(19) United States
(12) Patent Application Publication
(10) Pub. No.: US 2023/0172201 A1
(43) Pub. Date: Jun. 8, 2023

(54) Use of 4-Phenylbutyric Acid and/or 3-Phenylbutyric Acid and/or 2-Phenylbutyric Acid in Preventing and Treating Cryptogamic Diseases

(71) Applicants: Institut National de Recherche Pour L'Agriculture, L'Alimentation et L'Environnement, Paris (FR); Institut des Sciences et Industries du Vivant et de L'Envirinnement, Paris (FR); Centre National de la Recherche Scientifique, Paris (FR); Universite de Bourgogne, Dijon (FR); Université Bourgogne -Franche-Comté, Besancon (FR); Institut National Superieur des Sciences Agronomiques de l'Alimentation et de l'Environnement, Dijon (FR)

(72) Inventors: Jean-Luc Cacas, Montigny-Le-Bretonneux (FR); Damien Vasselon, Paris (FR); Olivier Lamotte, Glanon (FR); Benoît Poinssot, Dijon (FR); Anne-Sophie Walker, Saint Cyr L'Ecole (FR)

(73) Assignees: Institut National de Recherche Pour L'Agriculture, L'Alimentation et L'Environnement, Paris (FR); Institut des Sciences et Industries du Vivant et de L'Envirinnement, Paris (FR); Centre National de la Recherche Scientifique, Paris (FR); Universite de Bourgogne, Dijon (FR); Université Bourgogne -Franche-Comté, Besancon (FR); Institut National Superieur des Sciences Agronomiques de l'Alimentation et de l'Environnement, Dijon (FR)

(21) Appl. No.: 17/925,812

(22) PCT Filed: May 19, 2021
(86) PCT No.: PCT/EP2021/063221

§ 371 Date: Nov. 16, 2022

(30) Foreign Application Priority Data
May 20, 2020 (FR) 2005221

(51) Int. Cl. A01N 37/10; A01P 3/00

(52) U.S. Cl. CPC A01N 37/10; A01P 3/00

(57) ABSTRACT

The present invention relates to the use of 2-phenylbutyric acid, or 3-phenylbutyric acid, or 4-phenylbutyric acid, or one of their salts, or one of their combinations, to combat cryptogamic diseases caused by fungi and oomycetes. The present invention also relates to the use of these compounds and these combinations as fungicidal or fungistatic agents for the prevention or the curative treatment of cryptogamic diseases.

### PARENT PATENT APPLICATION

The present patent application claims the priority of French patent application No. FR 20 05221 filed on 20 May 2020. The content of the French patent application is incorporated by reference in its entirety.

### TECHNICAL FIELD

The present invention relates to the use of 4-phenylbutyric acid (4-PBA), 3-phenylbutyric acid (3-PBA), 2-phenylbutyric acid (2-PBA) or combinations thereof for preventing or treating diseases that affect plants and plant products and that are caused by fungi and oomycetes.

### CONTEXT OF THE INVENTION

Combating plant diseases is a major concern of agriculture. It is estimated that globally about one third of harvests is destroyed in the field or during storage by pathogens (insects, viruses, bacteria, oomycetes or fungi). This is reflected in considerable economic losses and may, in certain regions of the world, lead to problems of undernourishment or malnutrition of populations.

In future it is the fungi, more than viruses or bacteria, that are the most threatening microorganisms for food security and biodiversity. Since they are responsible for 70 to 90% of all plant diseases, a list has been drawn up of the ten scientifically and economically most important fungal pathogens (Dean et al., Mol. Plant Pathol., 2012, 13(4): 414-430). Magnaporthe oryzae, which causes rice blast disease in intensive rice monocultures, occupies first place in this list on account of its catastrophic potential for destroying world food supplies (Fry et al., BioScience, 1997, 47: 363-371). Rice blast disease and other plant diseases, such as soybean rust (Phakopsora pachyrhizi), wheat stem rust (Puccinia graminis), maize smut (Ustilago maydis) and late blight (Phytophthora infestans) contribute to the loss of 125 million tonnes of these crops (an amount sufficient to feed 600 million people), and cause a global loss of income of 60 billion US dollars (Fisher et al., Nature, 2012, 484(7393): 186-194). Moreover, although highly unlikely, it has been estimated that simultaneous epidemics of the 5 main food crops (rice, wheat, soybean, potato and maize) would lead to a catastrophic world famine, affecting 2.7 billion people (Fisher et al., Nature, 2012, 484(7393): 186-194). In the past, fungi have seriously compromised food security. For example, in the 1840s, the oomycete Phytophthora infestans caused the Great Famine in Ireland, leading to the death of a million people and the geographic displacement of another million people, resulting in a 20% decrease of the population of Ireland (Fry et al., BioScience, 1997, 47: 363-371). This event was not only a humanitarian tragedy, but also had a considerable effect on the development of Europe's political and economic history. In India, the Bengal famine of 1943 was responsible for the death of 2 to 4 million people—deaths resulting, at least partly, from the losses of rice crops caused by Cochliobolus miyabeanus (Padmanabhan, Annu. Rev. Phytopathol., 1973, 11, 11-24). In the south of the United States, Cochliobolus heterostrophus was the cause of a blight epidemic in the years 1971-72, which resulted in very large losses of harvests (Ullstrup, Annu. Rev. Phytopathol., 1972, 10: 37-50).

However, cryptogamic diseases are not “a thing of the past”, and the 21st century is far from being saved from them. The phenomenon is, on the contrary, growing rapidly. Today, one plant in eight, on average, will not yield fruit, on account of fungal diseases, despite the positive effect of crop protection policies. In addition, there is the appearance of virulent strains of phytopathogenic fungi. Thus, for example, Puccinia graminis, which is a formidable fungus responsible for wheat black rust, a virulent strain of which appeared in Uganda in 1999, has since spread to several countries in Africa and the Middle East and destroyed 80% of the harvests of certain regions in Africa at the beginning of the 2000s. This fungus, with a risk of spreading quickly beyond the regions already affected, could cause a disaster in wheat production and endanger global food security, especially as it has proved to be virulent against several resistance genes, which have previously protected wheat against black rust.

Today, we are poorly equipped to control the emergence and proliferation of fungal diseases and avoid loss of biodiversity and food shortages in the future. Therefore there is still a need for new strategies for combating cryptogamic diseases.

### SUMMARY OF THE INVENTION

The present invention relates generally to the use of 4-phenylbutyric acid (4-PBA) and/or 3-phenylbutyric acid (3-PBA) and/or 2-phenylbutyric acid (2-PBA) for preventing or treating cryptogamic diseases caused by fungi and oomycetes. The inventors have in fact shown that 4-PBA makes it possible to protect plants against gray rot caused by the fungus Botrytis cinerea, as 4-PBA has fungistatic or fungicidal activity; and that 4-PBA may be used more generally for treating a wide range of cryptogamic diseases caused by fungi or oomycetes. Compared to the chemical active ingredients currently commercially available, 4-PBA has the advantage that it is not toxic to humans or to the environment at the doses used, including for the plants to which it is administered. Moreover, it is relatively inexpensive. The inventors have shown, moreover, that 4-PBA is capable of limiting the growth of the primary hypha of several strains of Zymoseptoria tritici (or Mycosphaerella graminicola), displaying single resistance or multiple resistance to various classes of chemical fungicides commonly used. 3-Phenylbutyric acid (3-PBA) and 2-phenylbutyric acid (2-PBA) have also each been demonstrated to have this same fungistatic or fungicidal effect. Moreover, the combination of 3-PBA with 4-PBA, at respective concentrations at which neither of the two molecules displays antifungal activity in vivo, nevertheless makes it possible to protect the tomato against gray rot caused by Botrytis cinerea, revealing a synergy of action between these two molecules.

Accordingly, in a first aspect, the present invention relates to the use of 2-PBA, or 3-PBA, or 4-PBA, or a salt thereof, or a combination thereof, as a fungicidal or fungistatic agent, for preventing or treating a cryptogamic disease affecting a plant or a plant product. The cryptogamic disease is caused by a fungus or an oomycete.

The fungus or oomycete may be biotrophic, necrotrophic or hemibiotrophic. In certain preferred embodiments, the fungus or the oomycete is biotrophic.

In certain embodiments, the fungus is selected from the phytopathogenic fungi belonging to the genera Alternaria, Athelia, Armillaria, Aspergillus, Bipolaris, Blumeria, Botrytis (Cochliobolus), Carpenteles, Ceratocystis, Cercospora, Choanephora, Cladosporium, Claviceps, Colletotrichum, Cryphonectria, Diaporthe (Phomopsis), Erysiphe, Eurotium, Fusarium, Ganoderma, Gibberella, Glomerella, Magnaporthe, Macalpinomyces, Melampsora, Monilia, Moniliophthora, Microcyclus, Mycena, Mycosphaerella, Nectria, Neonectria, Olpidium, Penicillium, Pestalotia, Phakopsora, Phanerochaete, Phellinus, Physoderma, Pleospora, Podosphaera, Puccinia, Rhizoctonia, Rhizopus, Sclerotinia, Seiridium, Stemphylium, Septoria, Sphaerotheca, Sporisorium, Synchytrium, Taphrina, Tilletia, Thanatephorus, Trichoderma, Typhula, Ulocladium, Ustilago, Urocystis, Uromyces, Verticillium and Zymoseptoria.

In certain embodiments, the oomycete is selected from the phytopathogenic oomycetes belonging to the genera Albugo, Aphanomyces, Bremia, Peronospora, Peronosclerospora, Phytophthora, Plasmodiophora, Plasmopara, Polymyxa, Pseudoplasmopara, Pythium, Sclerophthora and Sclerospoara.

In certain embodiments, the plant is a field crop, a vegetable, an ornamental plant, a tree or a shrub.

In certain embodiments, the plant is a plant belonging to the family Malvaceae, Solanaceae, Cucurbitaceae, Cruciferae or Brassicaceae, Compositae or Asteraceae, Umbelliferae or Apiaceae, Liliaceae or Asparagaceae, Rosaceae, Polygonaceae, Lamiaceae, Vitaceae, Fabaceae, Poaceae, Liliaceae, Rubiaceae, Musaceae, Orchidaceae, Lauraceae, Alliaceae, Chenopodiaceae, Valerianaceae, Caprifoliaceae, Verbenaceae, Plantaginaceae, Scrofulariaceae, Ericaceae, Primulaceae, Oleaceae, Apocynaceae, Asclepiadaceae, Gentianaceae, Boraginaceae, Araliaceae, Grossulariaceae, Myrtaceae, Eleagnaceae, Lythraceae, Onagraceae, Thymeleaceae, Passifloraceae, Tiliaceae, Bombacaceae, Linaceae, Geraniaceae, Rutaceae, Violaceae, Cistaceae, Hypericaceae, Theaceae, Myristicaceae, Papaveraceae, Fumariaceae, Anonaceae, Renonculaceae, Caryophyllaceae, Fagaceae, Juglandaceae, Urticaceae, Moraceae, Santalaceae, Cannabinaceae, Piperaceae, Salicaceae, Betulaceae, Arecaceae, Zingiberaceae, Bromeliaceae, Pinaceae, Cupressaceae, Ginkgoaceae, Cycadaceae, Equisetaceae, Lycopodiaceae or Selaginellaceae.

The plant product may be selected from seeds, tubers, and bulbs. Alternatively, the plant product may be selected from fruits, vegetables, and post-harvest grains. The plant product may also be a pre-prepared food product. As a variant, the plant product may be post-cut wood, for example construction lumber.

In certain embodiments, the cryptogamic disease affecting the plant or plant product is selected from the group consisting of gray rot or botrytis, mildew or blight, Fusarium disease, cercosporiosis, oidium, alternariosis, anthracnosis, smuts, stinking smuts, septoriosis, moniliosis or monilia, rust, helminthosporiosis, sclerotiniosis, scab, verticilliosis, cladosporiosis, blister, coryneum or shot-hole disease, entomosporiosis, damping-off, esca, eutypiosis, gummosis, stony pit virus, mal secco, black leg, rice blast disease, and Dutch elm disease.

In certain embodiments, the cryptogamic disease is caused by a fungus or an oomycete resistant to at least one conventional fungicide (in particular a synthetic fungicide).

In certain embodiments, the cryptogamic disease is septoriosis of wheat caused by the fungus Zymoseptoria tritici, in particular a strain of Zymoseptoria tritici that has single resistance or multiple resistance to the conventional fungicides, such as fungicides belonging to the classes of benzimidazoles, cytochrome b inhibitors, succinate dehydrogenase inhibitors, or inhibitors of demethylation of sterols.

The use of 2-PBA, or 3-PBA, or 4-PBA, or a salt thereof, or a combination thereof as described here may result in an improvement in the storage of plant products (for example in the case of fruits, vegetables, post-harvest grains, in the case of pre-prepared food products, and in the case of post-cut wood). The use may also result in protection of the seeds and/or an improvement in the emergence of seedlings in the case of seeds.

Methods for carrying out the invention are also supplied here.

Thus, the invention also relates to a method for preventing or treating a cryptogamic disease in a plant or a plant product, said method comprising the application of 2-PBA, or 3-PBA, or 4-PBA, or a salt thereof, or a combination thereof, to the plant or to the soil surrounding the plant or to the plant product. The cryptogamic disease is caused by a fungus or an oomycete. Preferably, 2-PBA or a salt thereof, 3-PBA or a salt thereof, 4-PBA or a salt thereof, or a combination thereof, is applied in an effective amount for inhibiting the germination or growth of the fungus or oomycete, and/or for inhibiting the movement of the zoospores of the oomycete, and/or for destroying (causing the death of) the fungus or oomycete.

Accordingly, the invention also relates to a method for destroying a phytopathogenic fungus or oomycete and/or for inhibiting the growth of a phytopathogenic fungus or oomycete for preventing and/or treating a cryptogamic disease affecting a plant or a plant product, said method comprising application of 2-PBA or a salt thereof, of 3-PBA or a salt thereof, of 4-PBA or a salt thereof, or a combination thereof, to the plant and/or to the soil surrounding the plant or to the plant product.

In these methods, the fungus or the oomycete, the plant or the plant product, and the cryptogamic disease are as described above.

In certain embodiments, the uses and the methods according to the invention are characterized in that 2-PBA, or 3-PBA, or 4-PBA, or a salt thereof, or a combination thereof, is applied preemergence of the plant. Alternatively or additionally, 2-PBA, or 3-PBA, or 4-PBA, or a salt thereof, or a combination thereof, is applied post-emergence of the plant.

In certain embodiments, the uses and the methods according to the invention are characterized in that 2-PBA, or 3-PBA, or 4-PBA, or a salt thereof, or a combination thereof, is applied to the aerial parts of the plant, to the roots of the plant, to the seeds, tubers or bulbs of the plant, and/or to the fruits or grains of the plant.

The invention also relates to a method for improving the storage of a plant product that could be affected by a phytopathogenic fungus or oomycete, said method comprising the application of an effective amount of 2-PBA, or 3-PBA, or 4-PBA, or a salt thereof or a combination thereof, to the plant product, said method being characterized in that the effective amount is sufficient for inhibiting the germination or growth of the phytopathogenic fungus or oomycete, and/or for inhibiting the movement of the zoospores of the oomycete, and/or for destroying (causing the death of) the fungus or oomycete, and thus preventing a cryptogamic disease.

In this method, the fungus or the oomycete, the plant product, and the cryptogamic disease are as described above.

The invention also relates to a method for protecting seeds or for improving the emergence of seedlings, said method comprising the application of an effective amount of 2-PBA, or 3-PBA, or 4-PBA, or a salt thereof or a combination thereof, to seeds intended for sowing, said method being characterized in that the seeds are susceptible to being affected by a phytopathogenic fungus or oomycete and in that the effective amount is sufficient for inhibiting the germination or growth of the phytopathogenic fungus or oomycete, and/or for inhibiting the movement of the zoospores of the oomycete, and/or for destroying (causing the death of) the fungus or oomycete, and thus preventing a cryptogamic disease.

In certain embodiments of this method for protecting seedlings or for improving the emergence of seedlings, the phytopathogenic fungus or oomycete is responsible for damping-off, and the cryptogamic disease is damping-off.

The invention also relates to a phytosanitary composition comprising, as a fungicidal or fungistatic agent, 2-PBA, or 3-PBA, or 4-PBA, or a salt thereof, or a combination thereof.

The invention also relates to a solution for coating or forming a film on the seeds comprising, as a fungicidal or fungistatic agent, 2-PBA, or 3-PBA, or 4-PBA, or a salt thereof, or a combination thereof.

A more detailed description of certain preferred embodiments of the invention is given below.

### LEGENDS OF THE FIGURES

FIG. 1. Protection of thale cress (Arabidopsis thaliana, ecotype Columbia-0) against B. cinerea with 4-PBA. See Example 1.

FIG. 2. Protection of tomato (Moneymaker) against B. cinerea with 4-PBA. See Example 1.

FIG. 3. Protection of tomato (M82) against B. cinerea with 4-PBA. See Example 1.

FIG. 4. Protection of grapevine (Vitis vinifera cv. Gamay) against B. cinerea with 4-PBA. See Example 1.

FIG. 5. Evaluation of the effect of 4-PBA on the growth of Arabidopsis thaliana, and evaluation of the phytotoxicity of 4-PBA in Arabidopsis thaliana. See Example 2.

FIG. 6. Inhibition of the radial growth of the mycelium of B. cinerea with 4-PBA. See Example 3.

FIG. 7. Inhibition of the germination of the spores and growth of the primary hypha of B. cinerea with 4-PBA. See Example 3.

FIG. 8. Effect of 2-PBA and 3-PBA on the germination of the spores and the mycelial growth of B. cinerea in liquid medium in vitro, and the direct effect of 3-PBA on the growth of the primary hypha of B. cinerea in liquid medium in vitro. See Example 4.

FIG. 9. Protection of the tomato against gray rot with a combination of 4-PBA and an isomer thereof, 3-PBA. See Example 5.

FIG. 10. Inhibition of the radial growth of the mycelium from different species of phytopathogenic fungi with 4-PBA ((a) Fusarium graminearum, (b) Fusarium verticilloides, (c) Leptosphaeria maculans, (d) Helminthosporium teres and (e) Magnaporthe oryzae). See Example 6.

FIG. 11. Inhibition of the radial growth of the mycelium of different species of phytopathogenic fungi with 4-PBA ((a) Fusarium oxysporum f. sp. melonis, (b) Colletotrichum lindemuthianum, (c) Alternaria solani, (d) and (e) for the respective strains 1 and 1509 of Alternaria brassicicola, (f) Sclerotinia sclerotorum and (g) Cercospora beticola). See Example 6.

FIG. 12. Inhibition of the radial growth of two phytopathogenic oomycetes with 4-PBA. See Example 7.

FIG. 13. Inhibition of the radial growth of the mycelium of Phanerochaete chrysosporium with 4-PBA. See Example 8.

FIG. 14. Effect of increasing concentrations of 4-PBA on the growth of the primary hypha of seven isolates of the fungus Zymoseptoria tritici in vitro. The abscissa refers to the concentrations of 4-PBA (C) used in the test (expressed as decimal logarithm) whereas the ordinate refers to the percentage inhibition of the length of the primary hypha calculated relative to controls that have grown without 4-PBA. The characteristics of the seven isolates studied are presented in Table 4. See Example 9.

### DESCRIPTION OF THE EMBODIMENTS

As mentioned above, the present invention relates to the use of 4-phenylbutyric acid (4-PBA) or 3-phenylbutyric acid (3-PBA) or 2-phenylbutyric acid (2-PBA) or a salt thereof or a combination thereof as a fungicidal or fungistatic agent for preventing or treating a disease in a plant or a plant product.

### I—4-PBA, 3-PBA, 2-PBA, Salts Thereof and Combinations Thereof

1. 4-PBA and Salts Thereof

4-Phenylbutyric acid (also called 4-phenylbutanoic acid), 4-PBA, is a small molecule which, on account of its biological properties, has found application in the field of pharmacy and whose use in the field of agriculture has recently been proposed.

4-PBA is a chaperone molecule, i.e. a molecule that aids proteins in their maturation by ensuring appropriate three-dimensional folding (Cohen et al., Nature, 2003, 426: 905-909). Several studies have shown that, in mammals, 4-PBA inhibits stress of the endoplasmic reticulum and eliminates triggering of the UPR (Unfolded Protein Response). 4-PBA is approved for treating diseases of the urea cycle (Maestri et al., N. Engl. J. Med., 1996, 335: 855-859), and has been proposed as a therapeutic agent in the treatment of diseases such as type 2 diabetes and neurodegenerative diseases.

In plants, it has been reported that the application of 4-PBA to crops makes it possible to control the production of auxin (a plant growth phytohormone) and thus increase their yields (U.S. Pat. No. 6,245,717). The application of 4-PBA to plants has also been described as resulting in an improvement in resistance of the plants to abiotic stresses, such as drought, heat or aridity (US application 2012/0077677). It has been demonstrated that it is possible to prevent Fusarium disease of the spike, a disease caused by Fusarium graminearum, a necrotrophic fungus of the genus Fusarium, by applying chaperone molecules, such as 4-PBA, to crops (US application 2010/0261694), the chaperone molecule acting by suppressing programmed cell death of the plant cells caused by the fungus. Finally, the present inventors have described the antibacterial properties of 4-PBA and its use in treating and preventing plant diseases (WO 2014/009402).

In the context of the invention, 4-PBA can be used in the form of 4-phenylbutyric acid or in the form of a salt thereof. “Salt of 4-PBA” means any compound obtained by reacting 4-PBA, acting as an acid, with a suitable base to form, for example, a salt of an alkali metal, such as sodium, potassium, and lithium; a salt of an alkaline earth metal, such as calcium and magnesium; a salt of a transition metal, such as manganese, copper, zinc and iron; an ammonium salt; a phosphonium salt; a sulfonium salt; an oxonium salt; a choline salt; or else a salt with an organic base containing a nitrogen atom, such as trimethylamine, triethylamine, tributylamine, N,N-dimethylaniline, N-methylpiperidine, N-methylmorpholine, diethylamine, dicyclohexylamine, dibenzylamine, pyridine, guanidine, hydrazine and quinine. Preferably, a salt of 4-PBA used in carrying out the present invention is a sodium salt, potassium salt, calcium salt, magnesium salt, manganese salt, copper salt, zinc salt, iron salt, ammonium salt, phosphonium salt, sulfonium salt, or oxonium salt.

The 4-PBA may be synthesized by any method, for example by reaction of benzene with butyrolactone in the presence of aluminum chloride followed by neutralization in the presence of a base as described in U.S. Pat. No. 6,372,938.

2. 3-PBA and Salts Thereof

3-Phenylbutyric acid (also called 3-phenylbutanoic acid) is an isomer of 4-PBA. As noted above and as demonstrated in the experimental section, 3-phenylbutyric acid, just like 4-PBA, has fungistatic or fungicidal activity.

In the context of the present invention, 3-PBA can be used in the form of 3-phenylbutyric acid or in the form of a salt thereof “Salt of 3-PBA” means any compound obtained by reacting 3-PBA, acting as an acid, with a suitable base as indicated above in the case of 4-PBA. Preferably, a salt of 3-PBA used in carrying out the present invention is a sodium salt, potassium salt, calcium salt, magnesium salt, manganese salt, copper salt, zinc salt, iron salt, ammonium salt, phosphonium salt, sulfonium salt, or oxonium salt.

3-PBA can be synthesized by any method, for example by reaction (Fujisawa et al., Tetrahedron Letters, 1980, 21(22): 2181-2184). 3-PBA can also be obtained by degradation of hydrocarbons by certain microorganisms (Simoni et al., Applied and Environmental Microbiol., 1996, 62(3): 749-755; Le Thi Nhi-Cong et al., Journal of Basic Microbiology, 2010, 50(3): 241-253).

3. 2-PBA and Salts Thereof

2-Phenylbutyric acid (also called 2-phenylbutanoic acid) is an isomer of 2-PBA. As noted above and as demonstrated in the experimental section, 2-phenylbutyric acid, just like 4-PBA and 3-PBA, has fungistatic or fungicidal activity.

In the context of the present invention, 2-PBA may be used in the form of 2-phenylbutyric acid or in the form of a salt thereof “Salt of 2-PBA” means any compound obtained by reacting 2-PBA, acting as an acid, with a suitable base as indicated above in the case of 4-PBA and 3-PBA. Preferably, a salt of 2-PBA used in carrying out the present invention is a sodium salt, potassium salt, calcium salt, magnesium salt, manganese salt, copper salt, zinc salt, iron salt, ammonium salt, phosphonium salt, sulfonium salt, or oxonium salt.

2-PBA can be synthesized by any method (Aratake et al., Preparation of 2-phenylbutyric acids, Jpn. Kokai Tokkyo Koho, 1998, 4 pp). 2-PBA can also be produced by bacteria of the genus Nocardia when they are cultured in liquid medium in the presence of a hydrocarbon, phenyldodecane (Baggi et al., Biochem. J., 1972, 126: 1091-1097).

4. Combinations of 4-PBA, 3-PBA and 2-PBA

The inventors have demonstrated that the combination of 3-PBA with 4-PBA, at respective concentrations at which neither of the two molecules displays antifungal activity in vivo, nevertheless makes it possible to protect tomato against gray rot caused by the fungus Botrytis cinerea. A synergy of action between 3-PBA and 4-PBA has therefore been demonstrated. The terms “synergy”, “synergistic action” and “synergy of action”, which are used interchangeably here, denote a coordinated action of the two molecules, creating an effect greater than the sum of the effects expected if they had operated independently, or creating an effect that neither of them would have been able to obtain acting in isolation.

A combination of 3-PBA and 4-PBA (or salts thereof) can therefore be used advantageously in the context of the present invention. Here, “combination” means a pre-prepared mixture (or admixture) of the two molecules or else simultaneous administration, separate or sequential, of the two molecules. When administration is sequential or separate, the delay between administration of the first molecule and administration of the second molecule must be such that the beneficial synergistic effect of the combination is preserved. This also applies to a combination of 3-PBA and 2-PBA (or salts thereof) and to a combination of 2-PBA and 4-PBA (or salts thereof), whether or not there is synergy between the two molecules.

When a combination of 3-PBA and 4-PBA (or salts thereof) is a mixture (or admixture), this mixture may be prepared in any suitable proportions for attaining the required aim. Similarly, when a combination corresponds to the simultaneous administration, separate or sequential, of 3-PBA and 4-PBA (or salts thereof), the two molecules may be administered in any suitable ratio. Thus, 3-PBA:4-PBA ratio may vary from about 99:1 (w/w=weight/weight) to about 1:99 (w/w), and may be for example about 95:5 (w/w), about 90:10 (w/w), about 85:15 (w/w), about 80:20 (w/w), about 75:25 (w/w), about 70:30 (w/w), about 65:35 (w/w), about 60:40 (w/w), ab out 55:45 (w/w), ab out 50:50 (w/w), ab out 45:55 (w/w), ab out 40:60 (w/w), about 35:75 (w/w), about 30:70 (w/w), about 25:75 (w/w), about 20:80 (w/w), about 15:85, about 10:90 (w/w) or about 5:95 (w/w). The term “about”, as used here in referring to a number, generally comprises numbers that are located within a range of 10% in either direction of the number (greater than or less than the number), except in the case when this number exceeds 100% of a possible value. This also applies to a combination of 3-PBA and 2-PBA (or salts thereof) and to a combination of 2-PBA and 4-PBA (or salts thereof).

A combination of 3-PBA, 2-PBA and 4-PBA (or salts thereof) may also be used advantageously in the context of the present invention. Here, “combination” means a pre-prepared mixture (or admixture) of the three molecules or else simultaneous administration, separate or sequential, of the three molecules. Similarly, when a combination corresponds to simultaneous administration, separate or sequential, of 3-PBA, 2-PBA and 4-PBA (or salts thereof), the three molecules may be administered in any suitable proportions. Thus the 3-PBA:2-PBA:4-PBA ratio may vary from about 98:1:1 (w/w=weight/weight) to about 1:98:1 (w/w=weight/weight) to about 1:1:98 (w/w=weight/weight).

5. Compositions

Generally, 4-PBA, or 3-PBA, or 2-PBA, or a salt thereof, or a combination thereof, is applied to the plants or plant products in the form of an aqueous solution. 4-PBA, or 3-PBA, or 2-PBA, or a salt thereof, or a combination thereof may be used alone or in combination with other substances such as, for example, insecticides, acaricides, fungicides, nematicides, bactericides, herbicides, phytoprotective agents, plant growth regulators, supplements of nutrients, and/or fertilizers.

A phytopharmaceutical or phytosanitary composition comprising, as a fungicidal or fungistatic agent, 4-PBA, or 3-PBA, or 2-PBA, or a salt thereof, or a combination thereof, is an object of the present invention.

### II—Uses of 4-PBA, 3-PBA, 2-PBA, Salts Thereof and Combinations Thereof as Fungicidal or Fungistatic Agents

The inventors have demonstrated an antifungal effect of 4-PBA, 3-PBA, 2-PBA, of salts thereof and of combinations thereof (“the compounds and combinations described here”) on certain phytopathogenic fungi and oomycetes. “Antifungal” is intended to denote a substance that kills (fungicidal effect) fungi and/or oomycetes and/or that slows (fungistatic effect) the growth and/or multiplication of fungi and/or oomycetes. Accordingly, the invention relates to the use of 4-PBA, or a salt thereof, 3-PBA, or a salt thereof, 2-PBA, or a salt thereof, or a combination thereof, as a fungicidal or fungistatic agent for preventing and/or treating diseases caused by fungi or oomycetes in plants and/or plant products.

1. Phytopathogenic Fungi and Oomycetes

“Phytopathogenic fungi and oomycetes” is intended to denote fungi and oomycetes capable of causing diseases in plants and/or plant products. The inventors have demonstrated that 4-PBA has a very broad spectrum of action, having an activity against fungi that are very distant from a phylogenetic standpoint, whether these phytopathogens are biotrophic or necrotrophic or hemibiotrophic. The term “biotrophic” denotes a pathogen that colonizes the living tissues of a plant, and the term “necrotrophic” denotes a pathogen that kills the plant cells before colonizing them. The term “hemibiotrophic” denotes a pathogen having a short phase of biotrophic exploitation followed by a phase of necrotrophic exploitation. Thus, the present invention may be used for preventing or treating a disease that affects a plant or a plant product and is caused by a biotrophic, necrotrophic or hemibiotrophic fungus or oomycete.

a. Phytopathogenic fungi. The phytopathogenic fungi that can be destroyed or whose growth can be inhibited by one of the compounds and combinations described here may belong to any of the various groups of the kingdom of eumycetes or ‘true fungi’, namely the Ascomycetes, the Basidiomycetes and the Chytridiomycetes. The two most important groups of phytopathogenic fungi are the Ascomycetes, which cause for example gray rot or botrytis, the Fusarium diseases, oidia, septorioses, scab, and rye ergot, and the Basidiomycetes, which cause for example rusts and smuts.

The Ascomycetes (or Ascomycota) constitute an extensive division of the fungi, which are characterized by spores formed inside asci. They include many species useful to man such as the yeasts used in baking, brewing and vinification, edible fungi such as the morels and truffles, but also many phytopathogenic fungi of cultivated plants. The ascomycetes that cause cryptogamic diseases that can be prevented or treated using the present invention include Botrytis cinerea, which is responsible for the gray rot that ravages several crops of major agronomic interest such as grapevine, sunflower, tomato, strawberry. Botrytis cinerea is on the list of the ten scientifically and enonomically most important fungal pathogens, which was drawn up in 2012 (Dean et al., Mol. Plant Pathol., 2012, 13(4): 414-430). Another species of the genus Botrytis is Botrytis pseudocinerea, which has a broad spectrum similar to that of B. cinerea.

Other examples of phytopathogenic ascomycetes include the fungi of the genus Colletotrichum, which is one of the most important groups of phytopathogenic fungi worldwide. The fungi of the genus Colletotrichum attack more than 3200 species of monocotyledons and dicotyledons and are responsible for many cryptogamic diseases, in particular the anthracnoses, which are particularly detrimental when they affect fruits. The species of Colletotrichum are also on the list of the ten scientifically and enonomically most important fungal pathogens. Examples of species of the genus Colletotrichum (C.) include, without limitation, C. acutatum (which affects in particular the strawberry plant, blueberry plant, almond tree, citrus fruits, avocado, mango, olive tree, peach tree), C. arachidis, C. capsici (which affects basil, chickpea, pepper and pigeon pea), C. cereale (which affects turf), C. chlorophyti (which affects various species of herbaceous plants, in particular the legumes), C. coffeanum (which affects coffee trees), C. coccodes (which affects hop, tomato and potato), C. crassipes, C. dematium (which remains on crop residues, seeds and certain adventitious plants), C. dematium f. spinaciae (which affects sugar beet), C. gloeosporioides (which affects tomatoes and olives in particular), C. glycines (which affects soybean and tomato), C. gossypii (which affects cotton plants), C. graminicola (which affects cereals, and maize in particular), C. higginsianum (which affects many plants of the Brassicaceae family), C. kahawae (which affects berries of coffee trees on crops of Coffea arabica), C. lindemuthianum (which affects beans), C. lini, C. mangenotii, C. musae (which affects bananas and plantains), C. nigrum (which affects tomatoes), C. orbiculare (which affects melons and cucumbers), C. pisi, C. sublineola (which affects wild rice and sorghum), C. tabacum (which affects tobacco seedlings in nurseries), C. theaesinensis (which affects tea bushes), C. trifolii (which affects alfalfa), C. truncatum (which has a wide range of hosts and in particular affects pepper, aubergine, melon, chick pea, and grapes).

Other examples of ascomycetes causing cryptogamic diseases that can be destroyed or whose growth or germination can be inhibited using the present invention include the imperfect fungi or Deuteromycetes, which are septate fungi, with septate hyphae, which multiply asexually. The two major genera of deuteromycetes are: Fusarium and Aspergillus. The fungi of the genus Fusarium cause a disease called Fusarium disease. Two species of the genus Fusarium (F.) are on the list of the ten scientifically and enonomically most important fungal pathogens: F. graminearum (which affects cereals, in particular wheat, maize and barley) and F. oxysporum (which affects many cultivated plants such as the banana tree, cotton plant, melon, tomato, etc.). Other species of Fusarium include, without limitation, F. culmorum (which affects cereals, potato, asparagus, and which is responsible for various symptoms including damping-off), F. crookwellense (which affects numerous cultivated plants, including wheat, maize, raspberry, poplar, potato, etc.), F. euwallaceae (which affects many species of trees, in particular the leaves of Aceraceae, Fabaceae and Fagaceae, and which represents a serious threat to avocado crops), F. solani (which affects peas, beans, potato and many types of cucurbitaceae), F. sulfureum (which affects potato), F. avenaceum (which affects many cultivated plants such as wheat, maize, potato, raspberry, poplar, etc.), F. moniliforme (which is one of the most widespread fungi in basic food samples such as maize), F. proliferatum (which affects asparagus, maize, rice, and other crops), F. sporotrichioides (which affects cereal crops), F. subglutinans (which affects maize and mango), F. verticillioides (which affects wheat and maize), etc.

The deuteromycete fungi of the genus Aspergillus develop on decomposing organic matter, in the soil, compost, foodstuffs, and cereals. They do not attack plants while in full growth. For the most part they are classical saprophyta, which, taking advantage of wounds, penetrate into certain fruits or on seed plants, especially in hot, humid weather. When the seeds are harvested when wet (or if they get wet during storage), Aspergillus develop rapidly and transform into parasites, which leads to a decrease in germination capacity. Examples of species of the genus Aspergillus (A.) include, without limitation, A. niger (which is widespread on fodder, and maize seeds), A. flavus (which colonizes seeds of sunflower and Poaceae), A. ochraceus (which is phytopathogenic for apples and pears), A. terreus (which frequently occurs on ensiled cereals, straw, fodder and other plant substrates).

Other examples of phytopathogenic ascomycetes that can be killed or whose growth can be inhibited using the present invention include the fungi of the genus Podosphaera, which are responsible for various forms of oidium. The host plants mostly belong to the Rosaceae family. Examples of species of the genus Podosphaera (P.) include, without limitation, P. clandestina var. clandestina (which affects apricots and peaches), P. fusca (which affects melons and marrows), P. leucrotricha (which affects apples and pears), P. macularis (which affects hop, chamomile, cranberry, strawberries, hemp), P. pannosa (which affects plants of the rose family), P. tridactyla (which affects almonds), P. fuliginea (which affects the Cucurbitaceae).

Other examples of phytopathogenic ascomycetes include the fungi of the genus Mycosphaerella, in particular the anamorphic form: Spetoria, which is responsible for many diseases called septorioses. Examples of species of the genus Mycosphaerella (M) include, without limitation, M. arachidis, M. areola, M. berkeleyi, M. bolleana, M. brassicicola, M. caricae, M. caryigena, M. cerasella, M. coffeicola, M. confusa, M. cruenta, M. dendroides, M. eumusae, M. gossypina, M graminicola (which is on the list of the ten scientifically and enonomically most important fungal pathogens), M. henningsii, M. horii, M. juglandis, M. lageniformis, M. linicola, M. louisianae, M. musae, M. musicola, M. palmicola, M. pinodes, M. pistaciarum, M. pistacina, M. platanifolia, M. polymorpha, M. pomi, M. punctiformis, M. pyri. Examples of species of the genus Spetoria (S.) include, without limitation, S. dadauci, S. lactucae, S. leucanthemi, S. anthurii, S. bataticola, S. paeoniae, S. lycopersici, S. azaleae, S. hydrangeas, S. apiicola, S. chrysanthemella, S. adanensis, S. gladioli, S. petroselini, S. pisi, S. secalis, S. glycines, S. helianthi.

Other examples of phytopathogenic ascomycetes that can be killed or whose growth can be inhibited using the present invention include the fungi of the genus Monilia (which is the name given to the asexual form of Monilinia). These fungi are responsible for a disease of fruits called moniliosis. Examples of species of Monilia and Monilinia include, without limitation, Monilia/Monilinia laxa (which is responsible for moniliosis of fruit trees with fruits with pips), and Monilia/Monilinia fructigena (which is responsible for moniliosis of fruit trees with stone fruits).

Other examples of ascomycetes causing cryptogamic diseases that can be prevented or treated using the present invention include the fungi of the genus Sclerotinia, certain species of which cause white rot or sclerotiniosis. Examples of species of the genus Sclerotinia (S.) include, without limitation, S. minor (which affects carrots, tomatoes, sunflowers, peanuts and lettuce), S. cepivorum, S. sclerotiorum (which affects various plants including colza, sunflower, beans, carrot, etc.), S. trifoliorum (which affects alfalfa, red clover and chickpea), S. borealis (which affects barley, rye and wheat), S. bulborum (which affects plants with bulbs).

Other examples of phytopathogenic ascomycetes that can be destroyed or whose growth or germination can be inhibited using the present invention include the fungi of the genus Bipolaris (whose teleomorphic stage is Cochliobolus). This genus comprises more than 40 closely related species, many of which are pathogens of cereals, and are generally specific to one species of host plant, causing diseases of the group of the helminthosporioses in these plants. Examples of species of the genus Bipolaris (B.) include, without limitation, B. victoriae, B. cactivora, B. sorokiniana, B. zeicola, B. maydis, B. oryzae. Examples of species of the genus Cochliobolus (C.) include, without limitation, C. victoriae, C. sativus, C. carbonum, C. heterostrophus, C. miyabeanus.

Other examples of ascomycetes causing cryptogamic diseases that can be prevented or treated using the present invention include the fungi of the genus Alternaria and Ulocladium which cause a cryptogamic disease called alternariosis. Examples of species of the genus Alternaria (A.) include, without limitation, A. alternata, A. alternantherae, A. arborescens, A. arbusti, A. blumeae, A. brassicae, A. brassicicola, A. burnsii, A. carthami, A. cellosiae, A. cinerariae, A. cichorri, A. citri, A. conjuncta, A. chrysanthemi, A. cucumerina, A. dauci, A. dianthi, A. dianthicola, A. euphorbiicola, A. gaisen, A. helianthicola, A. hungarica, A. japonica, A. infectoria, A. leucanthemi, A. limicola, A. linicola, A. longpipes, A. macrospora, A. padwickii, A. molesta, A. panax, A. perpunctulata, A. petroselini, A. radicina, A. raphani, A. saponariae, A. senecionis, A. solani, A. tomata, A. tenuissima, A. triticina, A. chrysanthemi, A. porri, A. mali, A. helianthi, A. solani, A. triticina, A. zinniae. Examples of species of the genus Ulocladium include, without limitation, Ulocladium consortiale and Ulocladium chartarum.

Other examples of phytopathogenic ascomycetes that can be destroyed or whose growth or germination can be inhibited using the present invention include, without limitation:
the fungi of the genus Trichoderma, including the species Trichoderma viride which is the causative agent of green rot of onion and the wilting of plantlets of Pinus nigra (black pine);
the fungi of the genus Claviceps, which comprises about 50 known species, including the species Claviceps purpurea (which causes rye ergot and which parasitizes grasses and cereals), Claviceps fusiformis (which affects millet), Claviceps africana (which affects sorghum);
the fungi of the genus Ceratocystis (C.), which attack in particular fruit trees and forestry trees, including the species C. adiposa, C. coerulescens (which affects maple), C. fimbriata (which attacks very varied plants, ranging from the cacao tree to the sweet potato), C. oblonga and C. obpyriformis, which are saprobic species that affect species of Eucalyptus and the acacias;
the fungi of the genus Diaporthe (D.), whose anamorphic form is Phomopsis (P.), for example the species P. asparagi, P. asparagicola, P. cannabina, P. coffeae, P. ganjae, P. javanica, P. longicolla, P. mangiferae, P. prunorum, P. sclerotioides, P. theae, P. viticola and the species D. arctii, D. dulcamarae, D. eres, D. helianthi, D. lagunensis, D. lokoyae, D. melonis, D. orthoceras, D. perniciosa, D. phaseolorum, D. phaseolorum var. caulivora, D. phaseolorum var. phaseolorum, D. phaseolorum var. soja, D. rudis, D. tanakae, etc.;
the fungi of the genus Pestalotia, for example the species Pestalotia longiseta (which affects tea bushes) and Pestalotia rhododendri (which affects azaleas and rhododendrons);
the fungi of the genus Seiridium (which is the anamorphic form of the genus Lepteutypa), for example the species Seiridium cardinale (pathogen of cortical canker of the cypress);
the fungi of the genus Verticillium, which comprises pathogens and saprophyta that cause wilt diseases or vericilliosis, for example such as the species Verticillium alboatrum and Verticillium dahliae.
the fungi of the genus Cercospora (C.), which form foliar spots, for example the species C. angreci, C. apii, C. apiicola, C. arachidicola, C. asparagi, C. atrofiliformis, C. beticola, C. bolleana, C. brachypus, C. brassicicola, C. brunkii, C. cannabis, C. capsici, C. carotae, C. citrullina, C. coffeicola, C. coryli, C. orylina, C. eleusine, C. fragariae, C. fuschiae, C. fusca, C. fusimaculans, C. kikuchii, C. lentis, C. longpipes, C. longissima, C. mamaonis, C. mangiferae, C. medicaginis, C. melongenae, C. minima, C. minuta, C. musea, C. nicotianae, C. papayae, C. penniseti, C. pisa-sativae, C. plantanicola, C. rosicola, C. sojina, C. solani, C. sorhii, C. tuberculans, C. vexans, C. zeae-maydis, C. personata;
the fungi of the genus Cladosporium (C.), for example such as the species C. fulvum (which is responsible for mold of tomato leaves), C. cladosporioides and C. herbarum (which are responsible for vine rot), C. cladosporioides (which is responsible for rot of the flowers of strawberry plants), C. cucumerinum (which occurs on melons, courgettes and marrows), C. musae (which attacks banana trees);
the fungi of the genus Microcyclus, including the species Microcyclus ulei, which attacks trees of the genus Hevea;
the fungi of the genus Nectria, species of which affect fruit crops, for example Nectria cinnabarina (anamorphic stage: Tubercularia vulgaris) which affects apple trees and other species of trees or shrubs such as peach, currant, raspberry;
the fungi of the genus Penicillium, which is a genus of imperfect fungi (deuteromycetes), for example such as the species Penicillium digitatum and Penicillium italicum, which are agents of green and blue rots of citrus fruits;
the fungi of the genus Pleospora (P.), including the species P. alfalfae, P. betae, P. herbarum, P. papaveracea, P. lycopersici, P. tarda, and P. theae;
the fungi of the genus Magnaporthe, for example the species Magnaporthe oryzae (which is on the list of the ten scientifically and enonomically most important fungal pathogens and which is the primary pathogen of intensive rice monocultures, causing rice blast disease); and
the fungi of the genus Blumeria, including the species Blumeria graminis, which is the agent of a fungal disease called cereal white or cereal oidium, which affects certain plants of the Poaceae family.

The Basidiomycetes (or Basidiomycata or ‘agarics’), which make up an extensive division of the fungi, are characterized by spores formed at the end of specialized cells, the basidia. They include edible fungi and poisonous fungi. Among the phytopathogenic basidiomycetes that can be killed or whose growth can be inhibited using the present invention, we find the fungi of the genus Ustilago, which cause smut disease in many plant species, in particular the Poaceae (grasses). Examples of species of the genus Ustilago (U.) include, without limitation, U. maydis (which is on the list of the ten scientifically and enonomically most important fungal pathogens and is responsible for maize smut), U. avenae (which affects oat), U. esculenta (which affects maize, barley, oat, wild rice of Manchuria), U. nuda (which affects barley), U. tritici (which affects wheat), etc. Smuts may also be caused by phytopathogenic fungi of the genus Sporisorium (S.), examples of species of which include, without limitation, S. scitamineum (which is responsible for sugar cane smut), and S. cruentum, S. sorghi and S. ehrenbergii (all three of which cause sorghum smut). Smuts may also be caused by fungi of the genus Sporisorium, for example such as the species Sporisorium scitamineum, which is parasitic on plants of the genus Saccharum and is responsible for sugar cane smut.

Other examples of basidiomycetes that cause cryptogamic diseases of the smut type include the fungi of the genus Urocystis, which attack in particular grasses and other families of plants. Examples of species of the genus Urocystis (U.) include, without limitation, U. agropyri, U. arxanensi, U. brassicae, U. occulta, U. tritici or occulta, U. tranzscheliana, and U. xilinhotensis.

Other examples of phytopathogenic basidiomycetes include the fungi of the genus Puccinia, species of which are on the list of the ten scientifically and enonomically most important fungal pathogens. The fungi of the genus Puccinia are microscopic fungi responsible for fungal diseases called rusts, which may affect many plants, from the herbaceous stratum to large trees, as well as certain crops (potato, tomato, cereals, etc.). Examples of species of the genus Puccinia (P.) include, without limitation, P. asparagi, P. graminis, P. hordei, P. horiana, P., psidii, P. recondita, P. psidii, P. striiformis, P. triticina. Rusts may also be caused by fungi of the genus Uromyces (U.), examples of species of which include, without limitation, U. appendiculatus, U. trifolii, U. betae, U. decoratus, U. visiae-fabae, U. striatus, U. dactylidis, U. aloes, U. dianthi, U. graminis, etc. The fungi of the genus Melampsora may also cause rusts that can be prevented or treated using the present invention. Examples of species of the genus Melampsora (M.) include, without limitation, M. lini (which is one of the ten scientifically and enonomically most important fungal pathogens, and attacks flax), M. allipopulina (which attacks plants of the garlic family), M. pinitorqua (which attacks various species of pine), M. laricipopulina (which attacks larch), M. medisae (which attacks various hosts including larch).

Other examples of phytopathogenic basidiomycetes that can be destroyed or whose growth or germination can be inhibited using the present invention include the fungi of the genus Tilletia. This genus of fungi comprises about 175 phytopathogenic species that affect various species of plants of the Poaceae family (grasses) and are responsible in particular for stinking smuts of cereals. Examples of species of Tilletia (T.) include, without limitation, T. foetida or T. caries (which affects wheat), T. indicia (which affects wheat), T. pancicii (which affects barley), T. tritici (which affects wheat), T. secalis (which affects rye), T. controversa (which affects wheat and rye), T. horrida (which affects rice).

Other examples of phytopathogenic basidiomycetes include the parasitic fungi of the genus Armillaria, which are destructive forest pathogens that cause a root disease called white rot. Being an optional saprophyte, Armillaria also feeds on dead vegetable matter. Examples of species of the genus Armillaria include, without limitation, Armillaria heimii (which attacks tea bushes), Armillaria sinapina (which attacks willows, birches, and spruces).

Other examples of phytopathogenic basidiomycetes that can be killed or whose growth can be inhibited using the present invention include the parasitic fungi of the genus Ganoderma, which are saprophytic. This genus comprises many species pathogenic to plants, which are responsible in particular for the red rot disease that affects trees (generally broad-leaved trees) in the tropical regions. Examples of species of the genus Ganoderma (G.) include, without limitation, G. adspersum, G. applanatum, G. brownii, G. lobatum, G. lucidum, G. megaloma, G. meridithiae, G. orbiforme, G. philipii, G. sessile, Ganoderma tornatum, G. zonatum.

Other examples of phytopathogenic basidiomycetes that can be destroyed or whose growth can be inhibited using the present invention include, without limitation:
the parasitic fungi of the genus Moniliophthora, which originate from the tropical regions, for example such as the species Moniliophthora roreri (responsible for moniliosis or rot of the pods of the cacao tree) and Moniliophthora perniciosa (responsible for witches' broom disease, also in cacao trees);
the fungi of the genus Rhizoctonia (the sexual state of which is called Thantephorus), which are usually saprophytic but sometimes attack weakened live plants, for example field crops, in particular Rhizoctonia solani (which is one of the fungi responsible for damping-off, but which also attacks potato, cereals, sugar beet, rice), Rhizoctonia oryzae, Rhizoctonia cerealis, Rhizoctonia leguminicola, Rhizoctonia rubi; and
the fungi of the genus Phanerochaete (P.), species of which are capable of degrading the lignin of ligneous polymer to carbon dioxide and of causing white rot of conifers and broad-leaved trees, for example the species P. chrysosporium, P. allantospora, P. arizonica, P. avellanea, Phanerochaete burtii, P. carnosa, P. tuberculata, P. velutina.

The Chytridiomycetes (Chytridiomycota) or chytrids make up an extensive group of saprophytic or parasitic fungi, predominantly comprising aquatic fungi. Certain species of chytrid fungi may attack maize, alfalfa and some other plants. The Chytridiomycetes that cause cryptogamic diseases that can be prevented or treated using the present invention include for example Synthytrium endobioticum, which is the causative agent of potato wart disease.

Thus, the phytopathogenic fungi that can be destroyed or whose growth or germination can be inhibited using the present invention include, without limitation, the phytopathogenic fungi of the genera Alternaria, Athelia, Armillaria, Aspergillus, Bipolaris, Blumeria, Botrytis (Cochliobolus), Carpenteles, Ceratocystis, Cercospora, Choanephora, Cladosporium, Claviceps, Colletotrichum, Cryphonectria, Diaporthe (Phomopsis), Erysiphe, Eurotium, Fusarium, Ganoderma, Gibberella, Glomerella, Magnaporthe, Macalpinomyces, Melampsora, Monilia, Moniliophthora, Microcyclus, Mycena, Mycosphaerella, Nectria, Neonectria, Olpidium, Penicillium, Pestalotia, Phakopsora, Phanerochaete, Phellinus, Physoderma, Pleospora, Podosphaera, Puccinia, Rhizoctonia, Rhizopus, Sclerotinia, Seiridium, Stemphylium, Septoria, Sphaerotheca, Sporisorium, Synchytrium, Taphrina, Tilletia, Thanatephorus, Trichoderma, Typhula, Ulocladium, Ustilago, Urocystis, Uromyces, and Verticillium.

b. The phytopathogenic oomycetes. In the context of the present invention, the phytopathogenic oomycetes may belong to any of the various families of the Oomycetes (Oomycota) class, which comprises more than 90 genera and between 800 and 1000 species.

Thus, the phytopathogenic oomycetes that can be destroyed or whose growth or germination can be inhibited using the present invention include the oomycetes of the Albuginaceae family, which comprises a single genus Albugo. The genus Albugo comprises from 40 to 50 species of biotrophic parasites of flowering plants. Examples of species of Albugo (A.) that induce white rust include, without limitation, A. candida (which affects crucifers), A. tragopogoni ipomoeae-panduratae (which affects sweet potato), A. tragopogonis, A. occidentalis (which affects spinach), A. tragopogonis, A. horiana (which affects chrysanthemum), A. tragopogonis, A. tragopogoni (which affects sunflower).

Other examples of phytopathogenic oomycetes include, without limitation, the oomycetes of the family Peronosporales comprising the following genera: Bremia, Peronospora, Phytophthora, Plasmopara, Pseudoplasmopara, Sclerophthora and Sclerospoara, most being obligatory parasites responsible for mildew. Examples of species of the genus Bremia include for example Bremia lactucea (which is responsible for mildew of lettuce and artichoke). Examples of species of the genus Peronospora (P.) include, without limitation, P. antirrhini, P. arborescens, P. cactorum, P. destructor, P. farinosa, P. hyoscyamo, P. jaapiana, P. matthiolae, P. manshurica, P. oerteliana, P. spara, P. trifoliorum, P. viciae, P. violae, P. valerianellae. Examples of species of the genus Phytophthora (P.) include, without limitation, P. parasita (which affects Solanaceae—potato, tomato, tobacco, etc.), P. capsici (which is responsible for damping-off and which has a broad spectrum of action against pepper, tomato, aubergine, beans, pumpkin, winter squash, cucumber, melon, watermelon), P. cactorum, P. citrophthora, P. drechsleri, P. erythroseptica, P. infestans, P. megasperma, P. nicotianae, P. parasitica, P. phaseoli, P. sojae. Examples of species of the genus Plasmopara include in particular Plasmopara viticola which is an agent of grapevine mildew. Examples of species of the genus Sclerophthora include in particular Sclerophthora macrospora which is responsible for mildew of cereals, affecting cereals and various species of grasses. Examples of species of the genus Sclerospoara include in particular Sclerospora graminicola which affects maize and millet.

Other examples of phytopathogenic oomycetes that can be destroyed or whose growth or germination can be inhibited using the present invention include, without limitation, the oomycetes of the family Pythiales, which comprise the Pythium ssp., which are most often agents of damping-off (or pythium) for many types of wild and cultivated plants. Examples of species of the genus Pythium (P.) include, without limitation, P. acanthicum, P. aphanidermatum, P. aristosporum, P. arrhenomanes, P. buismaniae, P. camurandrium, P. prophyrae (which causes red rot), P. debaryanum, P. deliense, P. dissotocum, P. emineosum, P. graminicola, P. heterothallicum, P. hypogynum, P. irregulare, P. iwayamae, P. middletonii, P. myriotylum (which causes soft root rot in crops, such as peanut, tomato, rye, wheat, oat, cucumber, soybean, sorghum, tobacco, cabbage and maize), P. okanoganense, P. oopapillum, P. paddicum, P. perniciosum, P. rostratum, P. scleroteichum, P. spinosum, P. splendens, P. sulcatum, P. tracheiphilum, P. ultimum, P. violae, P. volutum.

Yet other examples of phytopathogenic oomycetes include, without limitation, the oomycetes of the family Saprolegniales, which comprise a single phytopathogenic genus: Aphanomyces. Examples of species of the genus Aphanomyces (A.) include, without limitation, A. euteiches (which is a major parasite of various legumes including fodder pea, alfalfa, and clover), and A. cochloides (which affects basic products such as spinach, Swiss chard, beets and other related species).

Thus, the phytopathogenic oomycetes that can be destroyed or whose growth or germination can be inhibited or else the movement of the zoospores can be inhibited using the present invention include, without limitation, the phytopathogenic fungi of the genera Albugo, Aphanomyces, Bremia, Peronospora, Peronosclerospora, Phytophthora, Plasmodiophora, Plasmopara, Polymyxa, Pseudoplasmopara, Pythium, Sclerophthora and Sclerospoara.

2. Plants and Plant Products

a. Plants. The invention may be applied to a large variety of plants, including field crops, vegetables, ornamental plants, trees and shrubs, whether in kitchen gardens, in the greenhouse or as a field crop.

In particular, the plants may be dicotyledons, such as in particular Malvaceae (e.g. cotton plant, etc.), Solanaceae (e.g. tobacco, tomato, potato, aubergine, etc.), Cucurbitaceae (e.g. melons, cucumber, watermelon, marrows, etc.), Cruciferae or Brassicaceae (e.g. colza, mustard, etc.), Compositae or Asteraceae (e.g. chicory, etc.), Umbelliferae or Asparagaceae (e.g. carrot, cumin, etc.), Rosaceae (in particular, trees and shrubs whose fruits are of economic importance), Polygonaceae (e.g. sorrel, rhubarb, buckwheat, etc.), Lamiaceae (e.g. basil, marjoram, mint, oregano, rosemary, savory, sage, thyme, etc.), Vitaceae (e.g. grapevine) or Fabaceae (e.g. peanut, bean, runner bean, lentil, petit pois, chick pea, soybean, etc.); or monocotyledons, such as in particular Cereales (e.g. wheat, barley, oat, rice, maize, etc.) or Liliaceae (e.g. onion, garlic, etc.). Other plants include Rubiaceae, Musaceae, Orchidaceae, Lauraceae, Alliaceae, Chenopodiaceae, Valerianaceae, Caprifoliaceae, Verbenaceae, Plantaginaceae, Scrofulariaceae, Ericaceae, Primulaceae, Oleaceae, Apocynaceae, Asclepiadaceae, Gentianaceae, Boraginaceae, Araliaceae, Grossulariaceae, Myrtaceae, Eleagnaceae, Lythraceae, Onagraceae, Thymeleaceae, Passifloraceae, Tiliaceae, Bombacaceae, Linaceae, Geraniaceae, Rutaceae, Violaceae, Cistaceae, Hypericaceae, Theaceae, Myristicaceae, Papaveraceae, Fumariaceae, Anonaceae, Renonculaceae, Caryophyllaceae, Fagaceae, Juglandaceae, Urticaceae, Moraceae, Santalaceae, Cannabinaceae, Piperaceae, Salicaceae, Betulaceae, Arecaceae, Zingiberaceae, Bromeliaceae, Pinaceae, Cupressaceae, Ginkgoaceae, Cycadaceae, Equisetaceae, Lycopodiaceae or Selaginellaceae.

In certain embodiments, a compound according to the invention is applied to a plant that is cultivated with the aim of producing food, ornamental plants, building materials (wood, straw), energy (firewood, ethanol, biodiesel), fibers (textile fibers, insulating materials), medicinal products (medicinal plants), and the like. Examples of cultivated plants include, without limitation, apricot tree, acacia, garlic, almond tree, pineapple, aniseed, peanut, artichoke, asparagus, aubergine, avocado, oat, banana tree, basil, bergamot tree, beet, wheat, broccoli, cacao tree, coffee tree, cinnamon tree, nasturtium, cardoon, carrot, carob tree, black currant bush, celery, chervil, cherry tree, hemp, chicory, cos lettuce, cabbage, cauliflower, Welsh onion, chives, lemon tree, pumpkin, clementine, coca shrub, coconut palm, quince tree, kola tree, colza, cucumber, coriander, cotton plant, courgette, cress, cumin, cypress, date palm, endive, spinach, tarragon, spelt, einkorn, strawberry plant, raspberry, fig, geranium, gentian, ginger, ginseng, guava, pomegranate plant, currant, guarana, marshmallow, hop, bean, iris, jasmine, kaki, kiwi, kola, lettuce, bay, lavender, lentil, lilac, flax, white lily, lychee, lupine, alfalfa, lily, corn salad, maize, mandarin tree, mango, cassava, melon, mint, millet, mustard, mulberry tree, nutmeg tree, turnip, winter rape, summer rape, hazel, walnut, onion, olive tree, orange tree, orchid, barley, oregano, watermelon, sweet potato, poppy, peach tree, parsley, pepper, peony, plantain, leek, pear tree, pea, pepper plant, pepper, potato, apple tree, pumpkin, plum tree, radish, horseradish, rhubarb, castor, rice, rocket, rose, rutabaga, saffron, salad plants, salsify, buckwheat, rye, sesame, sorghum, sedge, sweet sedge, marigold, tea bush, tomato, Jerusalem artichoke, clover, tulip, thyme, sunflower, triticale, lime, vanilla, verbena, grapevine, and the like.

Examples of plants cultivated with the aim of producing building materials include, without limitation, acacia, mahogany, service tree, alder, birch, cedar, cherry tree, chestnut, hornbeam, oak, cypress, Douglas fir, spruce, maple, ash, beech, yew, larch, walnut, olive tree, elm, poplar, Scots pine, plane tree, pear tree, fir, sycamore, lime, and the like.

In certain embodiments, the invention is applied to a transgenic plant. “Transgenic plant” means a plant obtained by techniques of genetic manipulation. More specifically, a transgenic plant is a plant in which at least one cell contains exogenous nucleotide sequences introduced through human intervention. Typically, transgenic plants express DNA sequences that endow these plants with one or more characters different than those of nontransgenic plants of the same species.

b. Plant products. The invention may also be applied to a plant product. Here, “plant product” means any plant or part of plant useful to humans. Thus, a plant product may be selected from seeds, tubers, and bulbs. Alternatively, a plant product may be selected from fruits, vegetables, and post-harvest grains. A vegetable may be a root (e.g. carrot, red beet), a tuber (e.g. potato, Jerusalem artichoke), a bulb (e.g. onion), a young shoot (e.g. asparagus), a pseudo-stem (e.g. leek), a petiole (e.g. beet, celery), a collection of leaves (e.g. lettuce, endive), a flower (e.g. artichoke, cauliflower), a fruit (e.g. tomato, cucumber), or a seed (e.g. pea, beans, runner beans).

Alternatively, a plant product may be a pre-prepared food product. The pre-prepared food products include fresh, raw, washed, peeled and cut agricultural products (conventional and mixed salad plants, raw vegetables, fresh herbs, vegetables and fruits) intended for consumption. The products are packaged under ambient air or a modified atmosphere or else under vacuum, in a bag or in a tray, and stored with refrigeration.

As a variant, a plant product may be wood post-felling or post-cutting (for example construction lumber). In the present context, with the aim of promoting sustainable development, wood is regaining the interest of manufacturers and the public at large. However, the natural biodegradable character of wood also constitutes the main barrier to its application and use. In fact, this material, which is particularly sensitive to its environment, is liable to be degraded by biological organisms. The use of wood in industry thus depends on its ability to resist these external attacks. Several factors are responsible for the development of fungi on cut wood: the time of cutting of the trees, the drying time, but also the final situation of the wood such as exposure to dampness, proximity of vegetation (forests), etc.

3. Cryptogamic Diseases

The plant diseases that can be treated according to the invention include any disease caused by a phytopathogenic fungus or oomycete that is destroyed and/or whose growth is inhibited by 4-PBA or a salt thereof, by 3-PBA and/or a salt thereof, by 2-PBA and/or a salt thereof, and/or by a combination thereof.

The cryptogamic diseases that can be prevented or treated by a method according to the invention include, without limitation, gray rot or botrytis, mildew, Fusarium disease, cercosporiosis, oidium, alternariosis, anthracnosis, smuts, stinking smuts, septoriosis, moniliosis or monilia, rusts, helminthosporiosis, sclerotiniosis, scab, verticilliosis, cladosporiosis, blister, coryneum or shot-hole disease, entomosporiosis, damping-off, esca, eutypiosis, gummosis, stony pit virus, mal secco, black leg, rice blast disease, and Dutch elm disease.

Gray rot or botrytis is a cryptogamic disease due to the fungus Botrytis cinerea (Botryotinia fuckeliana). Botrytis cinerea attacks a large number of cultivated plants (Vitaceae, Solanaceae, Cucurbitaceae, Rosaceae and Fabaceae). Viticulture, market gardening, arboriculture and floriculture are concerned by gray rot. This fungus is very often saphrophytic, i.e. it develops on dead or decomposing organic matter, and also has the characteristic of being able to develop on living matter, in particular flowers (for example on roses) or fleshy fruits (grapes, strawberries, etc.). The fruits or vegetables are covered with a characteristic brownish and then gray felting. The flowers affected wither and the leaves become covered with spots of a cream to brown color, and then they rot or dry. In general, the stems affected with spots dry out and the branch supporting them dies, and the roots rot.

Mildew is the generic name of a series of cryptogamic diseases affecting many plant species, but assuming epidemic proportions in certain crops of great economic importance, such as grapevine, tomato, potato, lettuce or marrows. These diseases are caused by oomycete microorganisms of the following genera: Plasmopara, Phytophthora, Peronospora and Sclerophthora. They are manifested as brown spots or the appearance of white, downy molds, followed by general wilting of the leaves, of a branch or of the whole plant. The tuber affected quickly rots, even during storage. Mildew may affect beet (Peronospora farinosa, and Peronospora farinosa f. sp. betae), apricot tree (Phytophthora cactorum), sugar cane (Peronosclerospora sacchari), carrot (Phytophthora megasperma and Plasmospora crustosa), strawberry (Phytophthora cactorum), stock (Peronospora matthiolae and Hyaloperonaspora cheiranthi), lettuce (Bremia lactucae), alfalfa (Peronospora trifoliorum), corn salad (Peronospora valerianellae), watermelon (Phytophthora dreschsleri), potato (Phytophthora infestans), primrose (Peronospora oerteliana), rhubarb (Peronospora jaapiana), artichoke (Bremia lactucae), tomato (Phytophthora infestans), grapevine (Plasmopara viticola), violet (Peronospora violae), spinach (Peronospora farinosa f. sp. spinaciae), onion (Peronospora destructor), citrus fruits (Phytophthora citrophthora and Phytophthora nicotianae var. parasitica), cereals (Sclerophthora macrospora), chenopadiaceae (Peronospora farinosa), crucifers (Hyaloperonospora parasitica), cucurbitaceae (Pseudoperonospora cubensis), pear trees (Phytophthora cactorum), celery (Plasmopara apii and Plasmopara crustosa), hemp (Pseudoperonospora cannabina), cabbage (Hyaloperonospora brassicae), the collar of the cherry tree (Phytophthora cactorum), the collar of the apple tree (Phytophthora cactorum), cucumber (Pseudoperonospora cubensis), strawberry plant (Phytophthora fragariae), bean (Phytophthora phaseoli), hop (Pseudoperonospora humuli), maize (Peronosclerospora maydis), snapdragon (Peronospora antirrhini), poppy (Peronospora arborescens), pepper (Phytophthora capsici), pea (Peronospora viciae), apple tree (Phytophthora cactorum), rose (Peronospora sparsa), soybean (Peronospora manshurica), sorghum (Peronospora manshurica, Peronosclerospora shorgi, Peronosclerospora philippinensis and Peronosclerospora sacchari), tobacco (Peronospora hyoscyami), sunflower (Plasmopara halstedii or Plasmopara helianthi), clover (Peronospora trifoliorum). Other forms of the disease include gray mildew of cotton (Mycophaerella areola), polyphagous tomato blight (Phytophthora cactorum), terrestrial tomato blight (Phytophthora nicotianae var. parasitica), and zoned tomato blight (Phytophthora nicotianae var. parasitica).

The Fusarium diseases are common fungal diseases of plants, which are caused by certain fungi commonly present in the soil, of the genus Fusarium but having parasitic development in these cases. These diseases develop in crops and may affect asparagus (Fusarium (F.) culmorum), bean (F. solani f. sp. phaseoli), pea (F. solani f. sp. pisi), beet (F. oxysporum f. sp. fetae), potato (F. coeruleum), maize (stem: Gibberella fujikuroi, F. culmorum and Gibberella zeae; spike: F. poae and F. tricinctum), vanilla (F. oxysporum f. sp. vanillae), pineapple (Gibberella fujikuroi var. subglutinans), carnation (F. oxysporum f. sp. dianthi), the Bromeliaceae (F. oxysporum f. sp. aechmea), bulbs (F. oxysporum f. sp. gladioli), cereals (Fusarium culmorum, Gibberella rosea, Gibberella avenacea, Gibberella intricans and Monographella nivalis), spikes (Gibberella zeae), asparagus roots (F. oxysporum f. sp. asparagi), the roots of Cactaceae (F. oxysporum f. sp. opuntiarum), the roots and the collar of tomatoes (F. oxysporum f. sp. radicis-lycopersici), the roots and the collar of cucumber (F. oxysporum f. sp. cucumerinum), wheat (Gibberella fujikuroi), cacao tree (Albonectria rigidiuscula), coffee tree (Gibberella stilboides), quince tree (Gibberella baccata), the collar of the cucurbitaceae (F. oxysporum f. sp. cucurbitae), cotton plant (F. oxysporum f. sp. vasinfectum), gladiolus (F. oxysporum f. sp. gladioli), flax (F. oxysporum f. sp. lini), maize (Gibberella acuminata, Gibberella fujikuroi var. subglutinans, and Gibberella zeae), oil palm (F. oxysporum f. sp. elaeidis), date palm (F. oxysporum f. sp. albedinis), soybean (F. oxysporum f sp. glycines and F. oxysporum f. sp. tracheiphilum), potato tuber (Gibberella cyanogena), and banana tree (F. oxysporum f. sp. cubensei). Vascular Fusarium disease may affect lentil (F. oxysporum f. sp. lentis), watermelon (F. oxysporum f. sp. niveum), tomato (F. oxysporum f. sp. lycopersici), tulip (F. oxysporum f. sp. tulipae), crucifers (F. oxysporum f. sp. conglutinans), coffee tree (Gibberella xylarioides), cabbage (F. oxysporum f. sp. conglutinans), chrysanthemum (F. oxysporum f. sp. chrysanthemi), cucumber (F. oxysporum f. sp. cucumerinum), cyclamen (F. oxysporum var. aurantiacum), strawberry plant (F. oxysporum f. sp. fragariae), bean (F. oxysporum f. sp. phaseoli), melon (F. oxysporum f. sp. melonis), pea (F. oxysporum f. sp. pisi), chick pea (Gibberella baccata and F. oxysporum f. sp. ciceris), and radish (F. oxysporum f. sp. raphani).

Oidium, or powdery mildew, is the generic name given to a series of cryptogamic diseases caused by the asexual form of certain ascomycete fungi belonging to the order Erysiphales and to the family Erysiphaceae. It mainly attacks certain tree species such as oak, maple, quince, apple or hawthorn, which are particularly sensitive to it. It is manifested by kinds of pustules appearing on leaves and fruits, and which may develop to form a white felting. Oidium may affect cashew nut (Oidium anacardii), tomato (Oidium lycopersici, Leveillula taurica and Oidium neolycopersici), beet (Erysiphe betae), heather (Oidium ericinum), carrot (Leveillula taurica), chicory (Golovinomyces cichoracearum), lettuce (Golovinomyces cichoracearum), alfalfa (Leveillula taurica), blueberry (Podosphaera myrtilllina), potato (Golovinomyces cichoracearum), verbena (Sphaerotheca verbenae), grapevine (Erysiphe necator), apricot tree (Podosphaera tridactyl), artichoke (Leveillula taurica), hawthorn (Podosphaera clandestina), alder (Microsphaera penicillata), endive (Golovinomyces cichoracearum), hevea (Oidium heveae), hydrangea (Microsphaera polonica), carnation (Oidium dianthi), citrus fruits (Oidium tingitaninum), berberis (Microsphaera berberidis), Borraginaceae (Golovinomyces cynoglossi), cereals (Blumeria graminis), honeysuckles (Erysiphe lonicerae), crucifers (Erysiphe cruciferarum), Cucurbitaceae (Golovinomyces cichoracearum, Golovinomyces orontii, Leveillula cucurbitacearum and Podosphaera fusca), Lamiaceae (Erysiphe biocellata), ornamental plants (Golovinomyces orontii), Solanaceae (Leveillula taurica), begonia (Microsphaera begoniae), cherry tree (Podosphaera clandestina), chestnut (Microsphaera penicillata), oak (Microsphaera alphitoides), chrysanthemum (Oidium chrysanthemi), quince tree (Podosphaera leucotricha), cucumber (Podosphaera fusca), cotton plant (Leveillula taurica), cyclamen (Oidium cyclaminis), strawberry plant (Podosphaera aphanis), raspberry (Podosphaera aphanis), ash (Phyllactinia fraxin), spindle tree (Erysiphe euonymi), currant bush (Podosphaera mors-uvae), bean (Podosphaera fusca), hop (Podosphaera macularis), lilac (Oidium syringae), flax (Golovinomyces orontii), mango (Oidium mangiferae), chestnut tree (Erysiphe flexuosa), pecan tree (Microsphaera penicillata), papaya (Oidium caricae-papapyae and Oidium indicum), peach tree (Podosphaera pannosa), plane tree (Erysiphe platani). Poinsettia (Oidium poinsettiae), pear tree (Podosphaera leucotricha), pea (Erysiphe polygoni f. sp. pisi), apple tree (Podosphaera leucotricha), rose (Podosphaera pannosa), soybean (Microsphaera diffusa), tobacco (Golovinomyces cichoracearum), clover (Microsphaera trifolii), and privet (Erysiphe ligustri).

Alternariosis, or Alternaria scorch disease, is the generic name of a series of fungal diseases due to various species of fungi of the genera Alternaria and Ulocladium. The fungus survives in the soil under plant debris in the form of mycelium, conidia or chlamydospheres. The conidia are spread by the wind or rain. Alternariosis may affect beet (A. alternata), carrot (A. dauci), chicory (A. cichorri), potato (A. alternata and A. solani), citrus fruits (A. alternata and A. citri), crucifers (A. brassicicola and A. brassicae), fruits (A. and U. chartarum), the Solanaceae (A. solani), wheat (A. triticina), safflower (A. carthami), cabbage (A. brassicae), chrysanthemum (A. chrysanthemi), cotton plant (A. macrospora), turnip (A. brassicae), leek (A. porri), apple tree (A. mali), sunflower (A. helianthi) and tobacco (A. alternata).

Anthracnosis is the generic name of a series of cryptogamic diseases caused by various species of phytopathogenic ascomycete fungi belonging to various genera (Apiognomania, Colletrotrichum, Discula, Gloeosporium, Glomerrela, Gnomonia, Pseudopeziza, etc.). Anthracnosis weakens the plant by decreasing the amount of foliage, it is harmful to fruit production, but does not threaten the life of the plant directly. Round brown spots from drying out appear on the fruits. Anthracnosis may affect banana (Colletotrichum musae), cranberry (Glomerella cingulata), bean (Didymella fabae and Aschochyta fabae), lettuce (Microdochium panattonianum), alfalfa (Colletotrichum destructivum and Colletotrichum trfolii), almond tree (Glomerella cingulata), sweet potato (Elsinoe batatas), peanut (Sphaceloma arachidis), tomato (Glomerella cingulata and Colletotrichum coccodes), grapevine (Elsinoe ampelina), aubergine (Glomerella cingulata), avocado (Sphaceloma perseae), spinach (Colletotrichum dematium f spinaciae), hevea (Glomerella cingulata), white onion (Colletotrichum circinans), olive tree (Colletotrichum acutatum and Colletotrichum gloeosporioides), orange tree (Elsinoe australis), elm (Stegophora ulmea), citrus fruits (Glomerella cingulata and Glomerella acutata), the berries of the coffee bush (Colletrichum kahawae), cereals (Glomerella graminicola), the Cucurbitaceae (Glomerella lagenarium), fodder vegetables (Kabatiella caulivora), the Liliaceae (Colletotrichum circinans), apples (Glomerella cingulata and Neofabraea alba), black currant bush (Drepanopeziza ribis f. sp. nigri), cherry tree (Blumeriella hiemalis), lemon tree (Glomerella cingulata), cotton plant (Glomerella gossypii), strawberry plant (Gnomonia fructicola, Glomerella acutata, Colletotrichum fragariae), raspberry (Elsinoe veneta), currant bush (Drepanopeziza ribis), bean (Colletotrichum lindemuthianum), jute (Colletotrichum corchorum), linseed (Colletotrichum lini), maize (Mycosphaerella zeae-maydis and Glomerella graminicola), mango (Colletotrichum gloeosporioides), walnut (Gnomonia leptostyla), oil palm (Cercospora elaeidis and Melanconium elaeidis), peach tree (Neofabraea malicorticis), pepper (Glomerella cingulata), plane tree (Gnomonia veneta), leek (Colletotrichum circinans), pear tree (Neofabraea malicortic and Elsinoe piri), pea (Phoma pinodella, Colletotrichum lindemuthianum, Didymella pisi and Didymella pinodes), chickpea (Mycosphaerella rabiei), pepper (Colletotrichum capsici), apple tree (Elsinoe piri and Neofabraea malicroticis), rose (Elsinoe rosarum), willow (Drepanopeziza salicis, soybean (Colletotrichum truncatum, Glomerella glycines and Sphaceloma glycines), tobacco (Colletotrichum tabacum), and clover (Colletotrichum destructivum).

Smuts are cryptogamic diseases caused by basidiomycete fungi mostly belonging to the Ustilaginomycotina subdivision. Smuts affect more particularly the plants of the family Poaceae (grasses) and in particular cereals, but also other cultivated plants. The economically most important hosts are maize (Ustilago maydis), barley (Ustilago segetum var. hordei), wheat, oat (Ustilago hordei f. sp. avenae), sugar cane (Ustilago scitaminea or Sporisorium scitamineum) and the fodder grasses. Smuts may also affect sorghum (Sporisorium sorghi), anemone (Urocystis anemones), potato (Thecaphora solani), grapevine (Elsinoe ampelina), violet (Urocystis violae), onion (Urocystis colchici), cork oak (Biscogniauxia mediterranea), gladiolus (Urocystis gladiolicola), maize (Ustilago maydis), millet (Ustilago crameri, Sphcelotheca destruens), wild rice of Manchuria (Ustilago esculenta). Other forms of smuts include, without limitation, stem smut (for example stem smut of grasses (Ustilago hypodytes), rye stem smut (Urocystis occulta)); spike smut (for example maize spike smut (Sphacelotheca reiliana); leaf smut (for example dahlia leaf smut (Entyloma calendulae f. sp. dahliae), rice leaf smut (Eballistra oryzae)); black smut (for example rice black smut (Tilletia barclayana)); loose smut (for example loose smut of oat (Ustilago segetum var. avenae), loose smut of barley (Ustilago segetum var. nuda), loose smut of wheat (Ustilago segetum var. tritici), loose smut of sorghum (Sphcelotheca cruenta)); stripe smut (for example stripe smut of millet (Ustilago striiformis)).

Septorioses are fungal diseases of plants caused by various species of fungi of the family Mycosphaerellaceae, in particular of the genus Septoria. These diseases, which affect a very large number of host plants, are characterized in particular by spots on the leaves and fruits and cankers of the stem. The main disease of this type, from the economic standpoint, is septoriosis of wheat, which affects wheat and other species of the genus Triticum and is encountered in all the wheat growing regions throughout the world. Mainly due to Septoria tritici and Speptoria nodorum, it may cause losses of yields of more than 40%. Epidemics may be very detrimental owing to their exponential development. Septoriosis may also affect carrot (Septoria dauci), lettuce (Septoria lactucae), daisy (Septoria leucanthemi), anthurium (Septoria anthurii), sweet potato (Septoria bataticola), peony (Septoria paeoniae), tomato (Septoria lycopersici), oat (Phaeosphaeria avenaria), azalea (Septoria azaleae), hydrangea (Septoria hydrangeae), barley (Zymoseptoria passerinii and Phaeosphaeria avenaria f. sp. triticea), brambles (Sphaerulina rubi), celery (Septoria apiicola), hemp (Didymella arcuata), chrysanthemum (Septoria chrysanthemella and Septoria adanensis), raspberry (Sphaerulina rubi), gladiolus (Septoria gladioli), currant (Mycrosphaerella ribis), parsley (Septoria petroselini), pear tree (Mycrosphaerella pyri), pea (Septoria pisi), rose (Sphaerulina rehmiana), rye (Septoria secalis), soybean (Septoria glycines), and sunflower (Septoria helianthi).

Moniliosis or monilia is the generic name of various fungal diseases of fruit trees caused by various species of fungi of the genus Monilinia, including Moniliniafructigena, which mainly attacks pome fruits, and Monilinia laxa, which attacks stone fruits. Moniliosis affects fruits that have been damaged (by hail, insect pricks and/or bites, bird pecks). The fruits are covered with brown patches and white spots distributed in ordered concentric circles. The fruits eventually rot on the tree and often remain mummified without falling. Almost all fruit species of the family Rosaceae (apple tree, pear tree, cherry tree, plum tree, peach tree, quince tree, apricot tree and almond tree) are sensitive to moniliosis. Moniliosis of the cacao tree (Moniliophthora roreri) is one of the most serious scourges of this crop (also known as glacial rot).

Rusts are cryptogamic diseases, for which the pathogens responsible are parasitic basidiomycete fungi of the order Pucciniales (formerly Uredinales). They are manifested by pustules that appear on the leaves. Certain rusts are due to oomycetes of the order Peronosporales (white rusts). These phytopathogens are obligatory parasites, which can only develop on a live plant. Rusts may affect garlic (Puccinia allii), aloes (Uromyces aloes), almond tree (Melampsora amygdalinae and Tranzschelia pruni-spinosae), peanut (Puccinia arachidis), asparagus (Puccinia asparagi), hawthorn (Puccinia substriata), banana tree (Uromyces musae), beet (Uromyces betae), heather (Thekopsora fischeri), sugar cane (Puccinia kuehnii and Puccinia melanocephala), chicory (Puccina hieracii), coffee tree (Hemileia vastratrix), celery (Puccinia apii), cherry tree (Puccinia cerasi), chrysanthemum (Puccinia chrysanthemi), quince tree (Gymnosporangium clavipes), cotton plant (Phakopsora gossypii and Puccinia cacabata), endive (Puccinia hieracii), fescue (Uromyces dactylidis), bean (Uromyces viciae-fabae), fig (Cerotelium fici), raspberry (Phragmidium rubi-idaei), gladiolus (Puccinia gladioli), guava (Puccinia psidii), currant bush (Puccinia ribis), bean (Uromyces appendiculatus), hydrangea (Pucciniastrum hydrangeae), iris (Puccinia iridis), lettuce (Puccina hieracci), flax (Melampsora lini), alfalfa (Uromyces striatus), Malvaceae (Puccinia malvacearum), cassava (Uromyces manihotis), maize (Puccinia polysora), millet (Puccinia substriata), mulberry tree (Cerotelium fici), mint (Puccinia menthae), medlar (Gymnosporangium confusium), Umbelliferae (Puccinia pimpinellae), peach tree (Puccinia cerasi), parsley (Puccinia nitida and Puccinia rubiginosa), poplar (Melampsora larici-populina and Melampsora populnea), pine (Cronartium comandrae), peony (Cronartium flaccidum), pistachio tree (Pileolaria terebinthin), leek (Puccinia porri), pea (Uromyces pisi and Uromyces viciae-fabae), chick pea (Uromyces ciceris-arietini), plum tree (Tranzschelia pruni-spinosae), reed (Puccinia phragmitis), rose (Phragmidium mucronatum), rhubarb (Puccinia phragmitis), Rosaceae (Phragmidium tuberculatum), salsify (Puccinia jackyana), fir (Pucciniastrum goeppertianum), soybean (Phakopsora pachyrhizi), sorghum (Puccinia purpurea), teak (Olivea tectonae), sunflower (Puccinia helianthi), clover (Uromyces trifolii), grapevine (Phakopsora euvitis). The rusts also include American rusts, Asian rusts, tropical rusts, trellis rusts or European rusts, white rusts, brown rusts, yellow rusts, orange rusts, black rusts, common rusts, collar rusts, stem rusts, needle rusts, leaf rusts, dwarf rusts, vesicular rusts, and vesiculate rusts.

Helminthosporiosis is a fungal disease caused by various species of ascomycete fungi and which mainly affects grasses, such as oat (Pyrenophora avenae and Cochliobolus victoriae—anamorph: Bipolaris victoriae), poppy (Pleospora papaveracea), barley (Pyrenophora graminae), cereals (Cochliobolus sativus—anamorph: Bipolaris sorokiniana), fodder grasses (Pyrenophora dictyoides), succulent plants (Bipolaris cactivora), jute (Corynespora corchorum), maize (Cochliobolus carbonum—anamorph: Bipolaris zeicola, Setosphaeria turcica—anamorph: Excerohilum turcicum, Cochliobolus heterostrophus—anamorph: Bipolaris maydis), rice (Cochliobolus miyabeanus—anamorph: Bipolaris oryzae) and rye (Pyrenophora japonica).

Slerotiniosis (also called white rot) is a cryptogamic disease due to attack of parasitic fungi of the genus Sclerotinia (Sclerotinia minor, Sclerotinia cepivorum and Sclerotinia sclerotiorum). It is one of the most devastating plant diseases throughout the world, affecting the yields and quality of about thirty crops of economic importance, including sunflower, carrot, artichoke, onion, colza, soybean, bean, pea, chick pea, etc.

Scabs are cryptogamic diseases caused by various fungi and affecting in particular apple trees (apple tree scab due to Venturia inaequalis), peach trees (black scab of peach tree due to Venturia carpophila), plum trees (plum tree scab due to Cladosporium carpophilum, pear trees (pear tree scab due to Venturia pyrina) and olive trees (olive tree scab or peacock's eye disease due to Spilocaea oleaginum). They damage both the leaves and the fruits.

Verticillium disease (also known as verticillium wilt or verticillium wilting) is a fungal disease that affects more than 300 species of annual, perennial, or woody herbaceous plants. This disease is caused by various species of ascomycete fungi, in the soil, of the genus Verticillium (family Plectosphaerellaceae). The distribution of the two main pathogens is different: Verticillium alboatrum is present especially in temperate zones whereas Verticillium dahliae is dominant in the tropical and subtropical zones.

Cladosporiosis of the tomato, also called olive mold, is a cryptogamic disease caused by the fungus Fulvia fulva (Cooke) Ciferri (or Cladopsorium fulvum Cooke). The disease is manifested by yellowish spots, which undergo gradual necrosis on the upper surface of the leaves, and by gray-green felting (mold) on the underside. It is only in the most severe cases that the flowers and fruits may be affected. In the case of early attack, i.e. before formation of the fruits, the losses of yields may be considerable.

Blister is a cryptogamic disease of the peach tree and almond tree, due to the fungus Taphrina deformans, which is reflected in distorted leaves and may cause considerable damage to trees producing peaches and nectarines.

Cryneum shot-hole disease is a disease caused by an ascomycete fungus Stigmina carpophila, formerly known as Coryneum beijerinckii. It attacks all of the aerial parts of the tree (branches, leaves and fruits) and affects fruit trees such as cherry trees, plum trees, peach trees, almond trees and apricot trees.

Entomosporiosis is a cryptogamic disease that particularly affects quince trees and is caused by Entomosporium maculatum. Red spots appear on the leaves, which turn yellow and eventually fall.

Damping-off is a disease that is characterized by the death of young seedlings, and which is very quickly contagious. The base of the young plants becomes gray and soft, and the plantlet dies in 24 hours. Several phytopathogenic fungi and oomycetes may cause the disease: Botrytis, Fusarium, Phytophthora, Rhizoctonia, Sclerotinia, Phoma, and Pythium, the latter being the commonest and the most feared.

Esca, or black measles of the grapevine, is one of the oldest diseases of the grapevine. It is attributed to three fungi with aerial dissemination: Phaeoacremonium aleophilium, Phaeomoniella chlamydospora and Eutypa lata.

Eutypiosis is a cryptogamic disease of the grapevine caused by a species of lignicolous ascomycete fungi, Eutypa lata. The symptoms of the disease include, for example, dwarfed branches, dwarfed leaves with chlorosis, and areas of brown necrosis on the wood.

Gummosis is a plant disease that is characterized by the flow of a gummy substance on the surface of the branches or trunk of certain trees. It affects more particularly certain deciduous trees, in particular fruit trees of the genus Prunus (cherry trees, plum trees, apricot trees and peach trees) and some others, such as citrus fruits. The fungus responsible (Cytospora, Botryosphaeria dothidea) is a lignicolous fungus, whose spores penetrate to the interior of the plant, as a result of wounds inflicted on the branches or the bark from any cause: pruning, breaking branches, splitting of bark, scratching by animals, insect attack, frost. These spores develop and form a mycelium, which invades and destroys the structure-forming wood of the tree on which it feeds.

Mal secco is a cryptogamic disease affecting citrus fruits, and more particularly the lemon tree (Citrus limon), the pathogenic agent of which is an ascomycete fungus of the order Pleosporales: Plenodomus tracheiphilus. Most often, the tree is infected as a result of wounds. This disease is a serious vascular disease that prevents sap from circulating correctly and leads to drying of the affected branch. The disease is propagated from the extremities to the trunk, leading in the short or medium term (1 or 2 years) to wilting of the plant, and then its death.

Black leg is a cryptogamic disease that is caused by the fungus Didymella and that causes necrosis of the collar (the part of a plant between the stem and the roots) in Brassicaceae, in particular cabbage and colza.

Rice blast disease is a cryptogamic disease caused by the fungus Magnaporthe grisea. It is the primary pathogen of intensive rice monocultures, causing necrosis of the stem at the level of the spikes. From an economic standpoint, this fungus, which is present in about 85 countries worldwide, is responsible for large losses each year. Magnaporthe grisea also attacks other Poaceae: wheat, rye, barley and millet.

Dutch elm disease, also called Dutch elm wilt, is a fungal disease caused by Osphiostoma ulmi. One of the first symptoms is distortion of the bark of the branches of the adult elm, and then the foliage dries out.

It is to be understood that other cryptogamic diseases apart from those mentioned here may be treated or prevented using the present invention.

### III—Methods of Use of 4-PBA, 3-PBA, 2-PBA, Salts Thereof and Combinations Thereof

Methods or processes are also supplied for carrying out the invention. In the methods according to the invention, the phytopathogenic fungi and oomycetes, the plants and the plant products, and the cryptogamic diseases are as described above.

Thus, the invention relates to a method for treating and/or preventing a cryptogamic disease in a plant or a plant product, comprising the application of 3-PBA or a salt thereof, 2-PBA or a salt thereof, 4-PBA or a salt thereof, or a combination thereof, to the plant and/or to the soil surrounding the plant or to the plant product. The cryptogamic disease is caused by a phytopathogenic fungus and/or oomycete.

In certain preferred embodiments, 3-PBA or a salt thereof, 2-PBA or a salt thereof, 4-PBA or a salt thereof, or a combination thereof, is applied in a sufficient (or effective) amount for inhibiting the germination or growth of the phytopathogenic fungus or oomycete and/or for inhibiting the movement of the zoospores of the phytopathogenic oomycete and/or for destroying (causing the death of) the phytopathogenic fungus or oomycete.

Accordingly, the invention also relates to a method for destroying a phytopathogenic fungus or oomycete and/or for inhibiting the growth of a phytopathogenic fungus or oomycete in order to prevent and/or treat a cryptogamic disease affecting a plant or a plant product, comprising the application of 3-PBA or a salt thereof, 2-PBA or a salt thereof, 4-PBA or a salt thereof, or a combination thereof, to the plant and/or to the soil surrounding the plant or to the plant product.

1. Application of 3-PBA, 2-PBA, 4-PBA, or a Combination Thereof to the Plants or Plant Products

In implementing the invention, application of one of the compounds and combinations described here may be carried out by any method known in the art. For example, application may be done by treatment of the soil or application to the soil (by watering, injection or spraying); by treating the culture substrates (vegetable mold, compost, etc.); by treatment using nutrient solutions; by irrigation (dropwise system or by spraying); by treatment of the aerial parts of the plant (by watering or spraying, or by fumigation in the case of crops in a greenhouse); by treating seeds (by film-coating or coating) or other propagation means (for example, by dusting tubers or seedlings, by dipping bulbs, cuttings or seedlings); by dipping or spraying fruits or vegetables after harvesting; by treating stored grains; by treating cut wood (for example by a surface impregnation process such as short dipping or by brush application or by spraying or else by a method of deep impregnation in an autoclave).

In the context of the present invention, “aerial parts of a plant” means the portion of the plant commonly called foliage, and which is located above the ground. In general, the aerial part or foliage of a plant comprises the leaves, stems, flowers, and fruits. Here, the term “fruit” has its definition used in botany, and therefore denotes the plant organ containing one or more seeds. The term “fruit” therefore also includes vegetables.

A person skilled in the art is able to determine the most suitable manners of application in relation to the pair phytopathogenic agent/plant or plant product and the desired effect (i.e. prevention or treatment of a cryptogamic disease or improvement of the storage of plant products after harvesting (vegetables, fruits, grains, etc.) or after cutting (wood), or optimization of the emergence of seedlings).

A person skilled in the art is also able to determine the optimal dose or doses of a compound or of a combination described here, to be applied to obtain the desired result. In general, the dose applied corresponds to a concentration that is not toxic to humans and the environment. In certain embodiments, the compound or combination is applied by spraying on the plants or parts of plants to be treated. In these embodiments, the compound or combination is preferably applied at a dose from 0.0005 to 3 kg/ha, more preferably from 0.001 to 2 kg/ha, and even more preferably from 0.005 to 1 kg/ha.

The term “effective amount”, as used here, denotes an amount of a compound or a combination that is sufficient to achieve the required aim (e.g. prevention of a cryptogamic disease, treatment of a cryptogamic disease, improvement of the preservation of plant products after harvesting (vegetables, fruits, grains, etc.) or after cutting (wood), optimization of the emergence of seedlings). An effective amount is not significantly toxic to the plant or plant product, or to humans or animals in the case of a treatment applied to products intended for human or animal consumption. An effective amount is generally between about 0.1 and about 1000 ppm (parts per million), preferably between 1 and 500 ppm. The precise effective amount of a compound or of a combination described here varies depending on the cryptogamic disease to be controlled, the type of formulation used, the method of application, the plant species or the nature of the plant product, the climatic conditions, etc. A person skilled in the art is able to determine an effective amount in relation to these various factors.

Moreover, a treatment according to the invention may correspond to a single application of a compound or combination described here or to several applications, for example applications that are specific lengths of time apart (e.g. a week apart, or a month or several months apart, etc.).

In the context of the present invention, 3-PBA or a salt thereof, 2-PBA or a salt thereof, 4-PBA or a salt thereof, or a combination thereof, may be applied preemergence and/or post-emergence of the plant. The terms “preemergence of the plant” and “prior to emergence of the plant” are used here indifferently and denote the period after sowing before the cultivated plant emerges from the soil. The terms “post-emergence of the plant” and “after emergence of the plant” are used here indifferently and denote the period when the cultivated plant has emerged from the soil.

A treatment with one of the compounds and combinations described here may result in a range of advantages for the plants and plant products. Such advantages may be manifested, for example, by a decrease in the presence, in the plant or in the plant product, in the number and/or severity of the symptoms of a cryptogamic disease caused by a fungus or oomycete; an improvement in the stability in storage of the plant once harvested (and/or of its fruits once picked); an improvement in the appearance of the plant or plant product due to the absence, or to the presence of a limited number of sites of necrosis, scorch, spots, rot, gall, tumor, or wilting in the tissues of the plant or plant product; an improvement of the biomass; an improvement of the growth of the roots; an improvement of the production of stolons; an increase in surface area of the leaves; an improvement of sexual and/or vegetative reproduction; an increase in the number of flowers; an increase in the volume of fruits; an improvement of the appearance of the fruits; an increase in the concentration of the nutrients and constituents such as, for example, carbohydrates, lipids, proteins, vitamins, minerals, and fibers, etc.

In the foregoing, an improvement, an increase, or a decrease of a property is generally of at least 3%, preferably of at least 5%, and even more preferably of at least 10% relative to a plant or a plant product that has not been treated with a compound or a combination described here.

2. Improvement of the Stability of Plant Products in Storage

The use of one of the compounds and combinations described here may result in an improvement of the preservation of plant products (for example fruits, vegetables and seeds after harvesting, pre-prepared food products, and post-cut wood). An improvement of preservation may translate into an increase in shelf life of plant products.

Accordingly, the present invention relates to a method for improving the storage of a plant product that is susceptible to being affected by a phytopathogenic fungus or oomycete, said method comprising the application of an effective amount of 3-PBA or a salt thereof, 2-PBA or a salt thereof, 4-PBA or a salt thereof, or a combination thereof, to the plant product, said method being characterized in that the effective amount is sufficient for inhibiting the germination or growth of the phytopathogenic fungus or oomycete or for inhibiting the movement of the zoospores of the phytopathogenic oomycete, or for destroying the phytopathogenic fungus or oomycete, and thus preventing a cryptogamic disease. The plant product may be selected from the group consisting of fruits, vegetables, seeds, pre-prepared food products, and cut wood.

3. Optimization of the Emergence of Seedlings

The use of one of the compounds and combinations described here may result in protection of seeds and an improvement in the emergence of seedlings.

In agriculture and in horticulture, seed treatment is the preparation of seeds intended for sowing, in particular using pesticides. The aim of this treatment is to protect the seeds or young plants against pathogenic microbes, in particular those naturally present in the soil, and animal parasites and stimulate germination and plant growth. Thus, for example, fungicidal protection of seeds remains indispensable against certain very detrimental diseases and for which there is no means of combating them on vegetation. Seeds coated with phytosanitary products with fungicidal and/or insecticidal action ensure preservation of the potential yield after sowing. Additives such as film-forming and coating agents facilitate sowing and improve the effectiveness of the treatments. Film-coating of seeds corresponds to application of a microporous film that makes it possible to fix the products with a very thin layer without changing the shape of the seed. Coating of seeds is a thicker form of covering of seeds, intended to facilitate sowing, and which may contain fertilizers, growth factors, as well as an inert filler and an outer polymer envelope.

In addition to reducing damage caused by diseases and maintaining the potential yield after sowing, the treatments of the seeds have the advantage of decreasing the use of phytosanitary products and therefore of reducing costs, working time and the handling of phytosanitary products by farmers. However, treatments of seeds are now controversial on account of risks to the environment (runoff, pollinators) and potentially to human or animal health.

The compounds of the present invention, which are more environmentally friendly, can replace the conventional phytopharmaceutical products in the treatment of seeds.

Accordingly, the invention relates to a method for protecting seeds or for improving the emergence of seedlings, said method comprising the application of an effective amount of 3-PBA or a salt thereof, 2-PBA or a salt thereof, 4-PBA or a salt thereof, or a combination thereof, to seeds intended for sowing, said method being characterized in that the seeds are susceptible to being affected by a phytopathogenic fungus or oomycete and in that the effective amount is sufficient for inhibiting the germination or growth of the phytopathogenic fungus or oomycete or for inhibiting the movement of the zoospores of the oomycete, or for destroying the phytopathogenic fungus or oomycete, and thus preventing a cryptogamic disease.

In certain embodiments, the cryptogamic disease is damping-off. Accordingly, the invention also relates to a method for preventing damping-off comprising the application of an effective amount of 3-PBA or a salt thereof, 2-PBA or a salt thereof, 4-PBA or a salt thereof, or a combination thereof, to seeds intended for sowing, said method being characterized in that the effective amount is sufficient for inhibiting the germination or growth of the phytopathogenic fungus or oomycete or for inhibiting the movement of the zoospores of the oomycete, or for destroying the phytopathogenic fungus or oomycete, and thus preventing a cryptogamic disease.

In certain embodiments, 3-PBA or a salt thereof, or 2-PBA or a salt thereof, or 4-PBA or a salt thereof, or a combination thereof, used in a method for protecting seeds, for improving the emergence of seedlings or for preventing damping-off, is present in a solution for coating or forming a film on seeds. Here, “coating” means a process that consists of coating the seeds by covering them with a material (generally polymeric) with the aim of making the size and shape of the seeds uniform in order to facilitate sowing. Here, “film-coating” means a process that consists of covering the seeds completely with a thin layer (or microporous film) in such a way that the seed retains its original shape. The solutions for coating and film-coating may generally contain additional ingredients such as pesticides.

The invention therefore also relates to a solution for coating or film-coating of seeds comprising, as a fungicidal or fungistatic agent, an effective amount of 3-PBA or a salt thereof, or of 2-PBA or a salt thereof, or of 4-PBA or a salt thereof, or of a combination thereof.

Unless they are defined otherwise, all the technical and scientific terms used in the description have the same meaning as commonly understood by an ordinary specialist in the field to which this invention belongs.

### EXAMPLES

The following examples describe certain embodiments of the present invention. However, it is to be understood that the examples are only presented for purposes of illustration and in no case limit the scope of the invention.

### Example 1: Protection of Plants with 4-PBA Against Gray Rot Caused by the Fungus Botrytis cinerea

1. Protection of Thale Cress (Arabidopsis thaliana, Ecotype Columbia-0)

Material and Methods. The seeds of Arabidopsis thaliana (Col-0) were sown directly in soil without a prior step of stratification. The plantlets were cultivated with short days (8 hours of daylight at a temperature of 21° C./16 h of night at a temperature of 18° C.) at a luminous intensity of 120 μE/m²/s, for 5 to 6 weeks. The mature leaves of the plants thus obtained were then inoculated with a solution of spores of the BMM strain of B. cinerea (consisting of 6 g/L of Potato Dextrose Broth or PDB medium [Sigma-Aldrich, P6685], the pH of which was 5.15) with or without 4-PBA at a final concentration of 1 mM. The stock solution of 4-PBA with a concentration of 10 mM was always prepared extemporaneousously. The inoculum was obtained from a sporulating mycelial culture aged from 10 to 14 days carried out in the dark at a temperature of 22° C. on sterile solid PDA medium (which was made up of 24 g/L of PDB medium and 15 g/L of agar). The inoculum was never stored for more than 10 days at 4° C. before use. It was diluted extemporaneously to a concentration of 5·10⁴ spores/mL before inoculation for all the experiments. On average, 3 to 4 leaves were inoculated per plant, at a rate of 6 μL of inoculum per leaf After inoculation, the plants were placed in a sealed container until the end of the experiment. The symptoms of the disease were photographed and quantified 4 days after inoculation. The longest diameter of the foliar lesions was measured using an electronic caliper gauge (CD-15DAX, Mitutoyo, Paris, France).

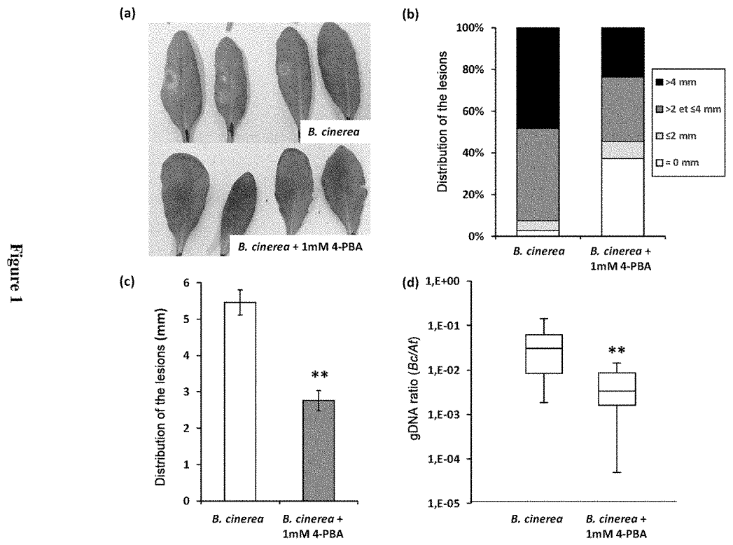

The intensity of the disease was also measured from the ratio of the foliar concentrations of genomic DNA of B. cinerea and of A. thaliana. Briefly, to extract the genomic DNA, the samples were ground in 200 mM Tris-HCl buffer, pH 7.5 containing 250 mM of NaCl, 25 mM of EDTA and 0.5% of SDS (v/v). The genomic DNA contained in the centrifugation supernatant (18,000×g for 10 minutes) was precipitated with isopropanol (v/v) at room temperature, and then sedimented by centrifugation. The pellet was then washed with 70% ethanol, then resuspended in 10 mM Tris-HCl buffer pH 8.0 containing 1 mM of EDTA and the DNA extracted was assayed by spectroprotometry. Ranges of concentrations of genomic DNA (gDNA) of the fungus and of the plant were carried out for determining the region of linearity in quantitative PCR (data not shown). These ranges allowed us to calculate the concentrations of gDNA derived from the 2 organisms in the foliar samples, as well as the ratios represented in figure id using a logarithmic scale (for further details see Gachon & Saindrenan, Plant Physiol. Biochem., 2004, 42: 367-371). Specific primers were used in quantitative PCR. The PCR reactions were carried out in a final volume of 10 μL containing 5 μL of Mastermix (Sso Advanced Universal SYBR Green Supermix, #172-5270, BioRad), 4.4 μL of DNA matrix diluted to the appropriate concentration and 0.3 μL of each of the two primers (final concentration of 3.3 μM per primer). The PCR conditions were as follows: 2 minutes at 50° C., 10 minutes at 95° C., then 15 seconds at 95° C. and 1 minute at 60° C.; the last two steps being repeated 39 times. The results in FIG. 1d give the mean values and standard deviations for 3 independent experiments, including 4 biological replicates (each consisting of 3-4 leaves) per condition (±4-PBA), per experiment.

Results. The figure shows symptoms representative of gray rot obtained on leaves of A. thaliana in the 5 independent experiments carried out in the presence and in the absence of 4-PBA. When the molecule was present in the inoculum, the relative proportions of the lesions (classified according to their diameter) observed after 4 days had changed relative to those of leaves inoculated with the fungus alone (FIG. 1b). In fact, 37% of the leaves inoculated with the solution of spores containing 4-PBA did not display symptoms whereas only 5% of the leaves infected with B. cinerea were free from lesions. Conversely, the molecule also allowed a decrease in the proportions of lesions whose diameter was greater than 4 mm, causing it to fall from 48% to 23%. The average diameter of the lesions was divided by 2.2 times (FIG. 1c). Finally, the lower intensity of the disease was corroborated by comparison of the ratios of gDNA of the fungus to that of the plant (FIG. 1d), which showed a median decrease by a factor of 10 on inoculation in the presence of 4-PBA.

This set of results demonstrates the capacity of 4-PBA for protecting thale cress (a plant of the family Brassicaceae) against development of the fungus B. cinerea.

2. Protection of Tomato (Solanum lycopersicum)

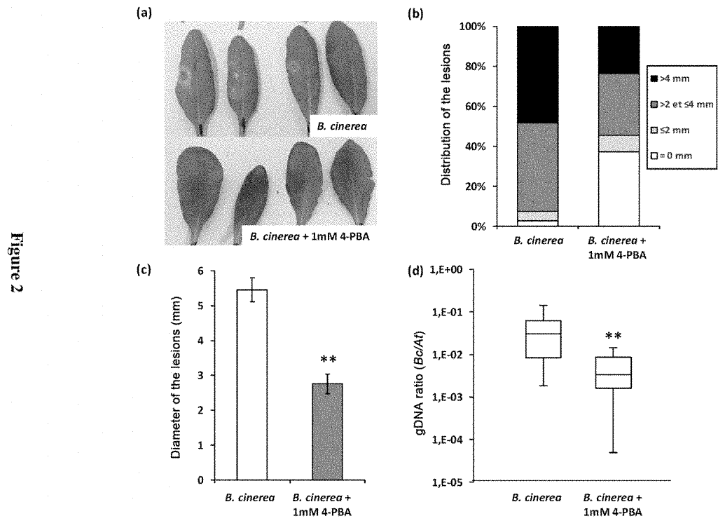

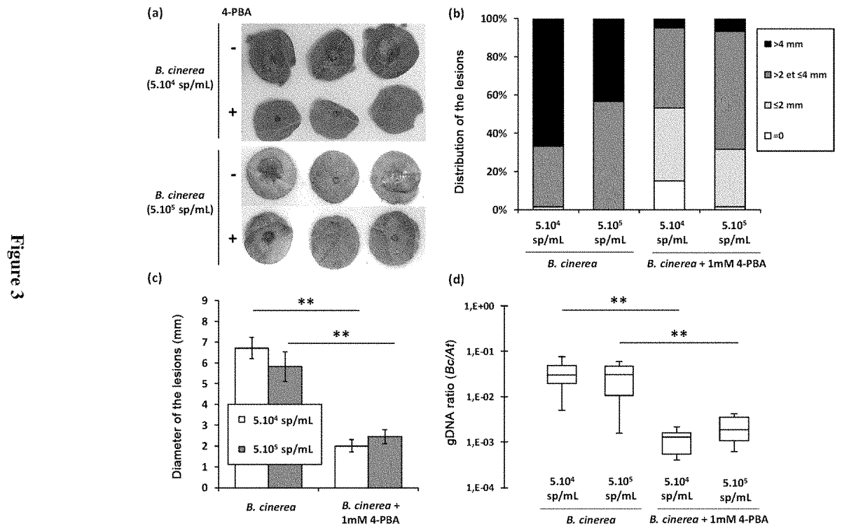

Material and Methods. Two commercial varieties of tomato (Solanum lycopersicum) were tested: one, called Moneymaker, intended for the production of tomatoes for the table, and the other, called M82, intended for the manufacture of Ketchup. The seeds were sown directly on compost without a prior step of stratification. The plantlets were cultivated with long days (16 hours of daylight at a temperature of 21° C./8 h of night at a temperature of 18° C.), at a luminous intensity of 120 μE/m²/s, for 5 to 6 weeks. Foliar disks (1.6 cm in diameter) of these two varieties were then cut with a punch on the terminal and subterminal leaves of branches 3 and 4 of the plants (counting starting from the lowest branch). These disks were placed in a Petri dish on Wattman 3M paper soaked with distilled water, at a rate of 20 disks per dish. The inoculum of the fungus B. cinerea (BMM strain), which was used for infecting the foliar disks, was prepared as in the example described above for thale cress. The disks were inoculated either with a solution of spores not containing 4-PBA, or with a solution of spores containing 4-PBA at a final concentration of 1 mM. Two titers of inoculum were tested with this experimental design: 5·10⁴ spores/mL and 5·10⁵ spores/mL. The volume of inoculum used was 3 μL per disk. For one dish, half of the disks were inoculated with the solution of spores containing 4-PBA, while the other half was inoculated with the solution not containing the molecule. After inoculation, the Petri dishes were sealed and placed in a phytotronic chamber in conditions with long days (16 hours of daylight at a temperature of 24° C. and 8 hours of night at a temperature of 19° C.) at an average luminous intensity of 300 μE/m²/s. The symptoms of the disease were photographed and quantified 3 days after inoculation. The longest diameter of the foliar lesions was measured using an electronic caliper gauge. The intensity of the disease was also measured from the ratio of the foliar concentrations of gDNA of B. cinerea and of S. lycopersicum as described above. Three independent experiments were carried out for each of the two concentrations of inoculum (5·10⁴ and 5·10⁵ spores/mL). Each of the experiments comprised twenty foliar disks per condition. The results presented correspond to the mean values of the three experiments±standard deviation. For the experiments of quantitative PCR, a biological replicate in one experiment corresponded to 5 foliar disks; i.e. four biological replicates per condition and per experiment. In FIGS. 2 and 3, ** indicates a statistically significant difference according to a Mann-Whitney nonparametric bilateral test with a risk α less than 1%.

Results. The results obtained for the Moneymaker variety are presented in FIG. 2. Panel (a) shows lesions characteristic of gray rot caused by the fungus B. cinerea on tomato. Less development of the fungus is observed visually on the foliar disks in the presence of 4-PBA. This observation is confirmed by the effects caused by 4-PBA on the distribution of the lesions by class of diameter (panel b) and on the average diameter of these lesions (panel c). In fact, with the molecule present in the inoculum, the proportions of lesions larger than 4 mm in diameter are greatly decreased, falling from 73% to 15% for a concentration of 5·10⁴ spores/mL and from 60% to 23% for a concentration of 5·10⁵ spores/mL. Moreover, the disks without lesions and/or with lesions smaller than 2 mm in diameter are widely represented in the population infected in the presence of 4-PBA (of the order of 35 to 40% depending on the titer of the inoculum); which is not the case in the absence of the compound. The effect of 4-PBA is also reflected in a decrease of the average diameter of the lesions, by 68% for the lowest concentration of spores and by 58% for the highest concentration. These results are corroborated by the ratios of gDNA of the fungus to that of the plant (panel d), since the median ratios are respectively 40 and 10 times lower for infections performed in the presence of 4-PBA than for those performed with the fungus alone at concentrations of 5·1⁰⁴ and 5·10⁵ spores/mL.

The results obtained for the M82 variety are presented in FIG. 3. These are similar to those obtained for the Moneymaker variety, showing an equivalent efficacy of 4-PBA for protecting the two tomato varieties against development of the fungus B. cinerea.

In conclusion, all of these data clearly demonstrate that 4-PBA, when it is in contact with the spores of the fungus B. cinerea at a final concentration of 1 mM, improves the foliar symptoms of gray rot for the 2 commercial varieties of tomato Moneymaker and M82. It will be noted, moreover, that the protective activity of the compound administered at this concentration is extremely robust, since an increase in the concentration of the inoculum by a factor of 10 only has a slight effect on the efficacy of the molecule.

3. Protection of the Grapevine (Vitis vinifera cv. Gamay)

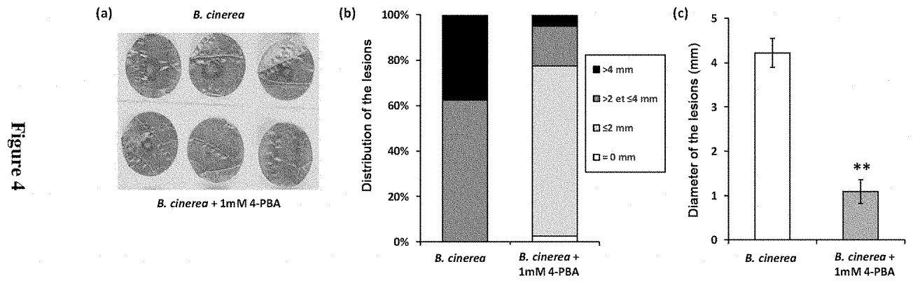

Material and Methods. A commercial variety of grapevine (Vitis vinfera, cultivar Gamay) was grown in a greenhouse for 6 weeks. Foliar disks with a diameter of 1.7 cm were then cut with a punch from leaves 1 and 2, and were inoculated with a solution of spores of the BMM strain of the fungus B. cinerea (5·10⁴ spores/mL) containing 4-PBA (at a final concentration of 1 mM) or not containing the compound. The inoculum was prepared as mentioned above for the experiments carried out with A. thaliana. A volume of 6 μL was deposited on each disk. The infected disks were incubated as for the experiments carried out on foliar disks of tomato. The disease symptoms were photographed and quantified 3 days after infection from the distribution of the lesions as a function of their diameter and by measuring the largest diameter of the lesions. One experiment was carried out on 40 foliar disks per modality (±4-PBA). The results presented in FIG. 4 correspond to the mean values±standard deviation. In this figure, ** indicates a statistically significant difference according to a Mann-Whitney nonparametric bilateral test with a risk α less than 1%.

Results. When it is directly in contact with the spores of the fungus, 4-PBA is capable of protecting the foliar disks of grapevine, showing an efficacy of protection similar to what was observed on thale cress and the two varieties of tomato, at an identical dose of inoculum (5·10⁴ spores/mL) and an identical final concentration of molecule (1 mM). In the presence of 4-PBA, in fact we observe a decrease in the average diameter of the lesions of the order of 75% (FIG. 4c), as well as a marked change in the distribution of the foliar symptoms in favor of smaller lesions (FIG. 4b).

All of the data presented here in Example 1 (FIGS. 1, 2, 3 and 4) demonstrate very clearly that the molecule 4-PBA is capable of effectively protecting against gray rot, 3 different plants belonging to quite distinct phylogenetic families and of obvious agricultural interest: the Brassicaceae, the Solanaceae and the Vitaceae.

### Example 2: Direct Effect of 4-PBA on the Plant Arabidopsis thaliana

1. Evaluation of the Effect of 4-PBA on the Growth of Arabidopsis thaliana

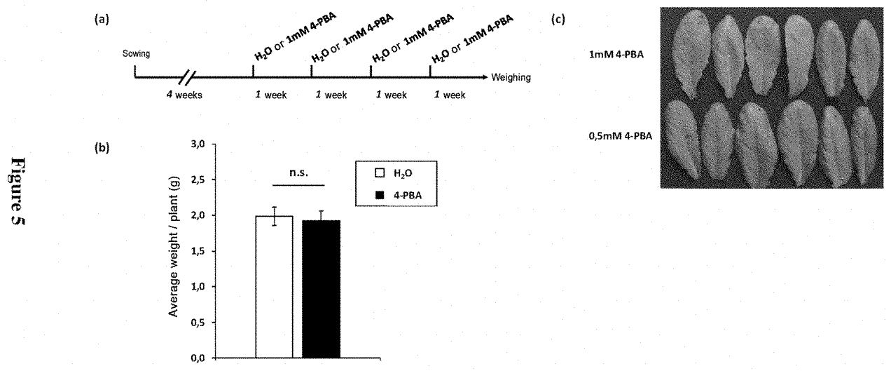

Material and Methods. The seeds of A. thaliana (ecotype Col-0) were sown in individual pots directly on compost without a prior step of stratification. In total, 24 plantlets were cultivated in short days (16 hours of daylight at a temperature of 24° C. and 8 hours of night at a temperature of 19° C.) at an average luminous intensity of 300 μE/m²/s, for 4 weeks. These plants were then separated into 2 batches with 12 plants each, one watered with distilled water, the other with a solution of 4-PBA at a final concentration of 1 mM. In practice, watering took place once a week on a fixed day and at a fixed time, for 4 consecutive weeks (FIG. 5a). They were watered by standing the pots in a basin for one hour using 500 mL of water or 500 mL of a solution of 4-PBA (prepared extemporaneously) depending on the batch of plants. The rosette of each of the plantlets was then weighed to evaluate the effect of watering with 4-PBA on vegetative growth. The data presented in FIG. 5b correspond to the mean values±standard deviation for one experiment, including 12 plants per condition. n.s. indicates absence of a statistical difference between the 2 mean values compared using a Student t test with a value α below 1%.

Results. In order to determine a possible effect of 4-PBA on vegetative growth, plants were watered regularly with a solution of 4-PBA or distilled water for the control batch (FIG. 5a). FIG. 5b presents the data obtained, showing an equivalent average weight per plant in the 2 culture conditions. The molecule 4-PBA therefore has no effect on the aerial biomass of A. thaliana when it is administered by watering at a concentration of 1 mM. It should be noted that this concentration is the concentration at which the molecule is effective for protecting thale cress, tomato and grapevine against B. cinerea (see Example 1).

2. Evaluation of the Phytotoxicity of 4-PBA in Arabidopsis thaliana

Material and Methods. Seeds of A. thaliana (ecotype Col-0) were sown in individual pots directly on compost without a prior step of stratification. The plantlets were cultivated in short days (8 hours of daylight at a temperature of 21° C./16 hours of night at a temperature of 18° C.) at an average luminous intensity of 120 μE/m2/s, for 5 weeks. A solution of 4-PBA (at a final concentration of 0.5 or 1 mM) was then infiltrated at the level of the abaxial face of the most developed leaves using a syringe without a needle, at a rate of 3 to 4 leaves infiltrated per plant. The experiment was repeated 3 times. Each experiment included about ten plants. Six leaves representative of the 3 experiments were photographed 48 hours after infiltration (FIG. 5c).

Results. The photograph presented in FIG. 5c shows absence of macroscopic symptoms 48 hours after infiltration of the leaves with a solution of 4-PBA, regardless of the concentration of the solution, 0.5 or 1 mM. These data suggest absence of toxicity of the molecule in the concentration range in which it is active for protecting the plants against cryptogamic diseases (see Example 1).

All the data presented in this second example suggest that treatment in the field by spreading the molecule might be possible in certain circumstances without negatively impacting the production yields of the plants.

### Example 3: Demonstration of the Antifungal Properties of 4-PBA on the Fungus Botrytis cinerea In Vitro

1. Inhibition of Radial Growth of the Mycelium of B. cinerea by 4-PBA

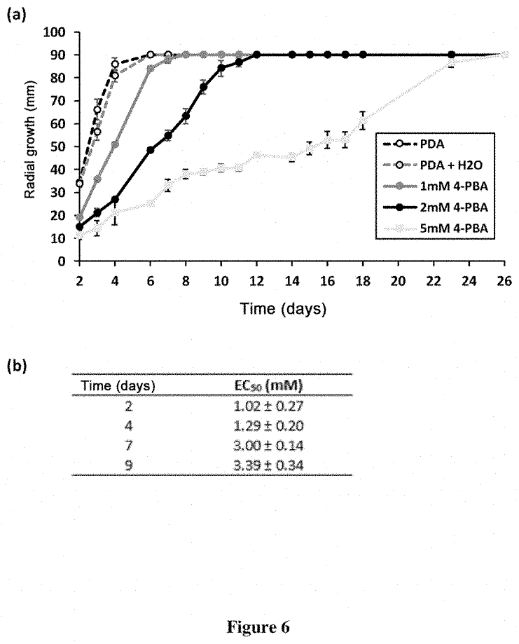

Material and Methods. The BMM strain of the fungus B. cinerea was cultured for about 10 days on solid PDA medium (24 g/L of PDB and 15 g/L of agar) in the dark and at a temperature of 22° C. A cylinder of agar comprising the mycelium at its top was then cut out with a sterile punch with a diameter of 6 mm, and was then deposited at the center of round Petri dishes (9 cm diameter) containing PDA medium supplemented or not with 4-PBA. 4-PBA, prepared extemporaneously, was added directly to the molten culture medium to final concentrations of 1, 2 and 5 mM. Controls were prepared by adding a volume of sterile water equivalent to the highest concentration of 4-PBA. The dishes were kept in the dark at a temperature of 22° C. throughout the experiment. The radial growth of the mycelium (expressed in mm) was monitored by measuring the longest diameter with an electronic caliper gauge over a period of 26 days. FIG. 6a presents the data obtained for 3 independent experiments, each comprising 2 biological replicates (mean values±standard deviations for n=6 at each kinetic point). These data made it possible to calculate the kinetic evolution of the median inhibitory concentration of 4-PBA (designated EC₅₀ in FIG. 6b) at which the radial growth of the mycelium is halved. For this, the following linear regression was used: Degree of inhibition (%)=f(ln[4-PBA]).

Results. Since 4-PBA is capable of protecting the plants when it is added directly to the inoculum (Example 1), this suggests a direct effect of the molecule on the fungus B. cinerea. This is what we wanted to verify by growing the fungus in the presence of the compound in vitro. The results obtained show that 4-PBA causes dose-dependent slowing of the radial growth of the mycelium (FIG. 6a). Moreover, even if the efficacy of the molecule decreases over time (increase in EC₅₀ presented in FIG. 6b), the persistence of the active principle may be up to 23 days when it is added to the culture medium at a concentration of 5 mM (FIG. 6a).

These results demonstrate a direct effect, at the minimum fungistatic, of 4-PBA with respect to the fungus B. cinerea.

2. Inhibition of Germination of the Spores and Growth of the Primary Hypha of B. cinerea by 4-PBA

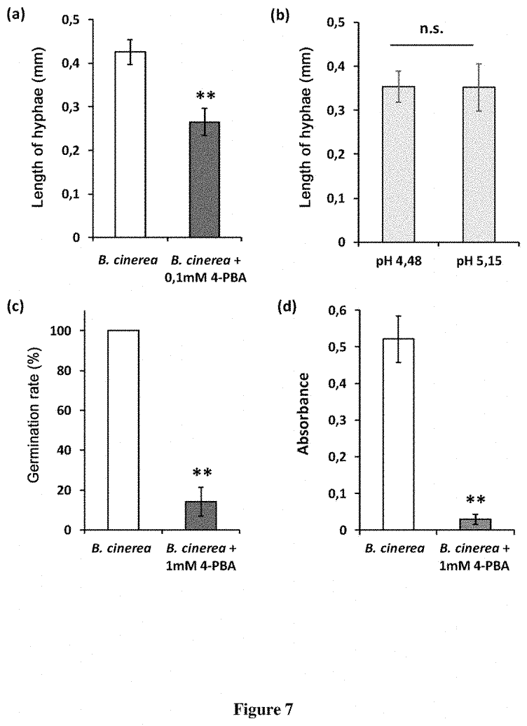

Material and Methods. A solution of spores of B. cinerea (BMM strain) was prepared as mentioned above in Example 1, at a concentration of 5·10⁴ spores/mL medium in PDB at 6 g/L. This suspension was supplemented or not with 4-PBA at the final concentrations indicated in panels a, c and d in FIG. 7. To determine the average length of the primary hyphae and the germination rate of the spores, 12 L drops of the 2 types of suspension were deposited on glass plates and the whole was incubated at saturating relative humidity for 16 to 18 hours, in the dark and at a temperature of 22° C. From photographs taken by optical microscopy, the length of the primary hypha (expressed in mm) was measured using Image J software (Schneider et al. Nature Methods, 2012, 9: 671-675) and the germination rate was calculated. Four independent experiments were carried out in this way (FIG. 7a, mean values±standard deviations for n=255 primary hyphae measured in control condition and n=311 primary hyphae measured in condition 4-PBA; FIG. 7c, mean values±standard deviations for n=499 spores counted in control condition and n=297 spores counted in condition 4-PBA). Mycelial development was also evaluated by measuring the absorbance at a wavelength of 600 nm (FIG. 7d). For this, a suspension of spores with a volume of 10 mL, supplemented or not with 4-PBA, was incubated for 4 days at room temperature before quantification by nephelometry. This experiment was repeated 3 times and each of the experiments comprised one biological triplicate, as well as one technical triplicate per biological replicate. For these experiments, a Mann-Whitney nonparametric bilateral test was performed in order to determine the statistical differences. ** indicates a significant difference between the 2 mean values with a risk a less than 1%.

To evaluate the influence of pH on the growth of the primary hyphae of B. cinerea (FIG. 7b), the pH of the liquid culture medium was adjusted to a pH of 4.48 using a solution of hydrochloric acid before sterilization; addition of 4-PBA to a final concentration of 1 mM to this medium (whose pH is 5.15) caused a decrease of 0.67 pH unit. Drops of 12 μL of the 2 types of suspension (5·10⁴ spores/mL) were deposited on glass plates and the whole was incubated at saturating relative humidity for 16 to 18 hours, in the dark and at a temperature of 22° C. From photographs taken by optical microscopy, the length of the primary hypha (expressed in mm) was measured using Image J software (Schneider et al. Nature Methods, 2012, 9: 671-675). The results obtained for 4 independent experiments are presented in FIG. 7b (mean values±standard deviations for n=544 primary hyphae measured at a pH of 4.48 and n=643 primary hyphae measured at a pH of 5.15). For these experiments, the statistical differences were evaluated by a Student t test. n.s. indicates absence of a significant difference between the 2 mean values with a risk α fixed at 5%.

Results. For a better understanding of the effect of 4-PBA on the development of B. cinerea, tests in liquid medium were carried out in vitro as described above. The results in FIG. 7a confirm the fungistatic activity of the molecule observed previously on solid medium (FIG. 6a). Starting from a concentration of 0.1 mM, 4-PBA is in fact capable of limiting the growth of the primary hypha of the fungus (but without affecting the germination rate of the spores, which was 100% for these 4 independent experiments, data not shown). At a 10 times higher concentration (i.e. 1 mM), 4-PBA thus possesses powerful antigerminative activity, which is reflected in inhibition of the germination of the spores of 86% (FIG. 7c) and strong repression of mycelial growth (94%) measured by nephelometry (FIG. 7d). However, since 4-PBA is a weak acid, it was noted that it caused a decrease in pH of the culture medium (of from 5.15 to 4.48) when it is added to it to a final concentration of 1 mM. To find out whether this decrease in pH could be responsible for the inhibition of the germination rate observed, spores were incubated for 16 to 18 hours (in the absence of 4-PBA) either in a culture medium at a pH of 4.48, or in a culture medium at a pH of 5.15 (FIG. 7b). In these two conditions, the germination rate was 100% (data not shown) and the average length of the primary hyphae was statistically comparable. These results clearly demonstrate that the fungistatic activity of 4-PBA, whether it is antigerminative or is exerted on the growth of the primary hypha, is independent of the pH and relates to an activity intrinsic to the molecule.

All the data described for this example suggest strongly that the protective activity of 4-PBA against gray rot (reported for thale cress, tomato and grapevine) is exerted at least via a direct effect on the fungus; an activity of stimulation of the plants' defenses could not be ruled out at this stage. However, this protection of the plants results at the least from a fungistatic activity of the compound. The potential fungicidal activity of 4-PBA is being studied.

### Example 4: Demonstration of the Antifungal Properties of the Isomers of 4-PBA on the Fungus Botrytis cinerea In Vitro

1. Effect of 2-PBA and 3-PBA on the Germination of the Spores and the Mycelial Growth of B. cinerea in Liquid Medium In Vitro

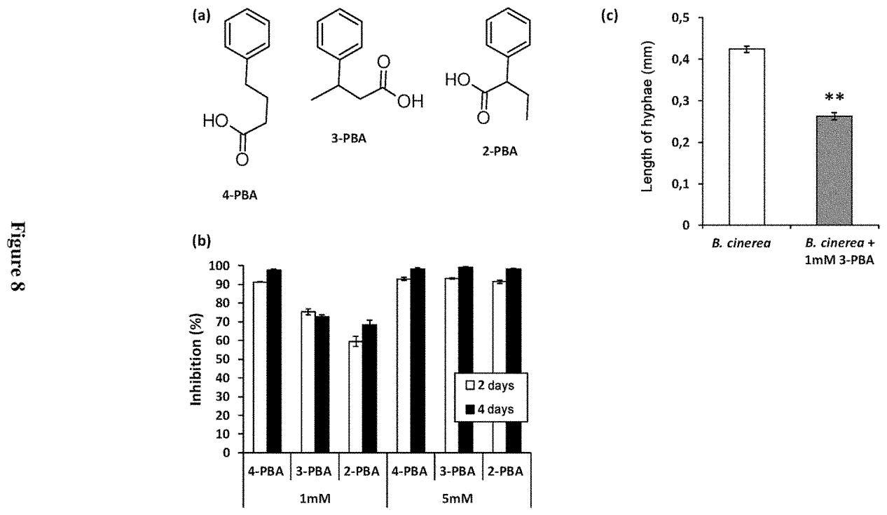

Material and Methods. As in Example 3 (paragraph 2), mycelial development was evaluated by measuring the absorbance at a wavelength of 600 nm. For this, a suspension of spores (5·10⁴ spores/mL) with a volume of 10 mL, supplemented or not with phenylbutyric acids (2-, 3- or 4-PBA) at the concentrations indicated in FIG. 8b, was incubated for 2 and 4 days at room temperature before quantification by nephelometry. This experiment was repeated twice and each of the experiments comprised one biological triplicate, as well as one technical triplicate per biological replicate. The degree of inhibition reported (expressed in %) was calculated by comparing with controls for which the medium was inoculated with the fungus alone.

Results. FIG. 8a presents, from left to right, the structural formulas of 4-phenylbutyric acid, and of its two isomers, 3-phenylbutyric and 2-phenylbutyric acids. While the 3 molecules show a comparable relative efficacy for repressing the growth of B. cinerea in liquid medium at a final concentration of 5 mM (whatever the incubation time, 2 or 4 days), the 2 isomers are less effective compared to 4-PBA at a final concentration of 1 mM. After incubation for 4 days, for example, the degree of inhibition caused by 2-PBA and 3-PBA is close to 70%, whereas that caused by 4-PBA is 97%. It will be noted, nevertheless, that these degrees of inhibition are still relatively high for a fungus such as B. cinerea, whose growth in a rich medium is extremely rapid.

Like 4-PBA, the two isomers therefore also have fungistatic activity, demonstrated in vitro on the fungus B. cinerea.

2. Direct Effect of 3-PBA on the Growth of the Primary Hypha of B. cinerea in Liquid Medium In Vitro

Material and Methods. The influence of 3-PBA on the growth of the primary hypha of the fungus B. cinerea was measured in the same conditions as those described for 4-PBA in Example 3-2. The data reported in FIG. 8c represent mean values±standard deviation for 2 independent experiments (n=217 primary hyphae measured in the control condition and n=110 primary hyphae measured in condition 4-PBA). A Mann-Whitney nonparametric bilateral test was performed in order to determine the statistical differences. ** indicates a significant difference between the 2 mean values with a risk a less than 1%.

Results. Just as for 4-PBA, 3-PBA has fungistatic activity that limits the growth of the primary hypha of B. cinerea (FIG. 8c). This activity, demonstrated in vitro, is reflected by a 38% decrease in the average length of the hyphae. This confirms the data presented in FIG. 8b.

### Example 5: Protection of Tomato Against Gray Rot by a Combination of 4-PBA and One of its Isomers, 3-PBA

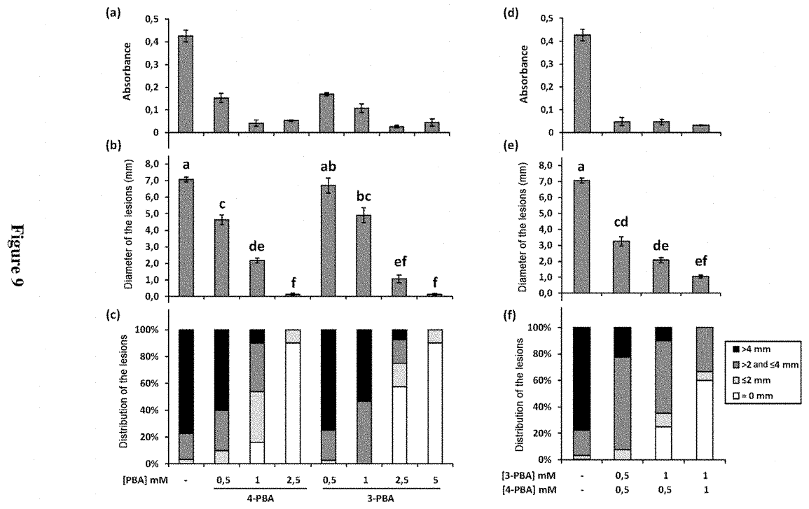

Material and Methods. The absorbance tests presented in panels a and d in FIG. 9 were carried out as described in Example 3-2, except that the measurements were made 3 days after inoculation of the culture medium and that they are derived from a technical duplicate. The solutions of spores used are those that were used for inoculation of the foliar disks of the M82 tomato variety. Two independent experiments on inoculation of disks were carried out as described in Example 1-2. The data of these experiments are presented in the form of mean values±standard deviation (panels b and e) and in the form of mean values (panels c and f). A Kruskal-Wallis nonparametric bilateral test (according to the Conover-Iman procedure for paired multiple comparison) was applied for determining the statistically significant differences between the average diameters of the lesions measured for each of the conditions (threshold a less than 1%). Identical letters indicate absence of a significant difference between samples, and vice versa.

Results. When foliar disks of tomato are inoculated with solutions of spores containing increasing concentrations of 4-PBA (from 0.5 to 2.5 mM), a decrease in intensity of the symptoms of the disease is observed. It is characterized by a gradual decrease in the average diameters of the foliar lesions as a function of the concentration of the compound (FIG. 9b) and a parallel increase in the proportions of lesions of small diameter (less than 2 mm), as well as of those of disks without symptoms (FIG. 9c). This effect, which is dependent on the dose on the plant, mirrors what occurs in vitro (decrease in absorbance with the concentration of 4-PBA, FIG. 9a), showing that protection of the plant tissues with 4-PBA is exerted at the minimum by a direct effect on the fungus. The experiments performed with inocula containing only 3-PBA indicate a similar trend (FIG. 9a,b,c), with the notable exception that the isomer, at equivalent concentration, is less effective than 4-PBA for protecting the foliar disks from gray rot. In fact, it is necessary to reach for example a concentration of 5 mM of 3-PBA to obtain a similar effect to that of 4-PBA at a concentration of 2.5 mM. These data are in agreement with the interpretations made for FIGS. 7 and 8.

For the prospect that 4-PBA and its isomers might be usable in combination for optimizing the efficacy of a future treatment and limiting the appearance of resistant fungi (since it is more difficult for a microorganism pathogen to evade two active principles than just one), the efficacy of protection against B. cinerea with a combination of 4-PBA and 3-PBA was evaluated at various concentrations. In these conditions, the combination of the 2 molecules at concentrations of 0.5 mM each is reflected in an effect of potentiating synergy on the growth of the fungus in vitro (FIG. 9d), the average diameter of the lesions (FIG. 9e) and the distribution of the symptoms (FIG. 9f), since the effect observed on these different parameters is greater than that resulting from the sum of the effects caused by the compounds alone. Regarding the other two combinations of concentrations, the synergistic effect is mainly additive and is expressed at the level of the diameter of the lesions and the distribution of the latter.

In conclusion, this set of data demonstrates that 3-PBA is itself also effective for protecting plants against development of B. cinerea and that the combination of 4-PBA with its isomer is even more effective than the two molecules used separately.

### Example 6: Inhibition of the Radial Growth of the Mycelium of 12 Species of Phytopathogenic Fungi by 4-PBA

Material and Methods. The fungi and oomycetes studied, as well as their respective growth temperature and culture medium, are described in Table 1 below.

TABLE 1

| | | Culture | Culture |
|---|---|---|---|
| Fungi and oomycetes | Strains | media | temperature |
| Botrytis cinerea | BMM | PDA/PDB | 22° C. |
| Fusarium graminearum | — | PDA | 28° C. |
| Fusarium verticilloides | — | PDA | 22° C. |
| Leptosphaeria maculans | PL1 | PDA | 22° C. |
| Helmintosporium teres | HT1 | PDA | 22° C. |
| Magnaporthe oryzae | — | Rice flour | 22° C. |
| Sclerotinia sclerotorum | — | V8 Agar | 22° C. |
| Colletrotrichum lindemuthianum | — | PDA | 22° C. |
| Fusarium oxysporum f. sp melonis | — | PDA | 22° C. |
| Alternaria solani | B055 | PDA | 22° C. |
| Alternaria brassicicola | 1 | PDA | 22° C. |
| Alternaria brassicicola | 1509 | PDA | 22° C. |
| Cercospora beticola | 18294 | PDA | 22° C. |
| Phytophthora parasitica | 310 | V8 Agar | 22° C. |
| Phytophthora capsici | 450 | V8 Agar | 22° C. |
| Phanerochaete chrysosporum | RP78 | PDA | 22° C. |

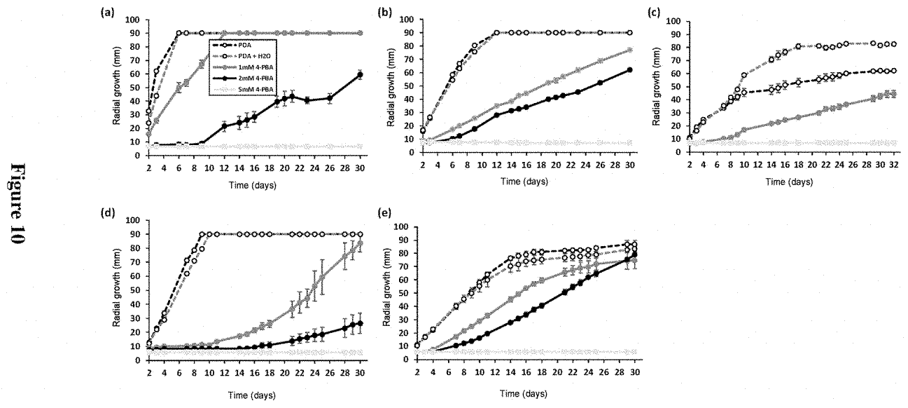

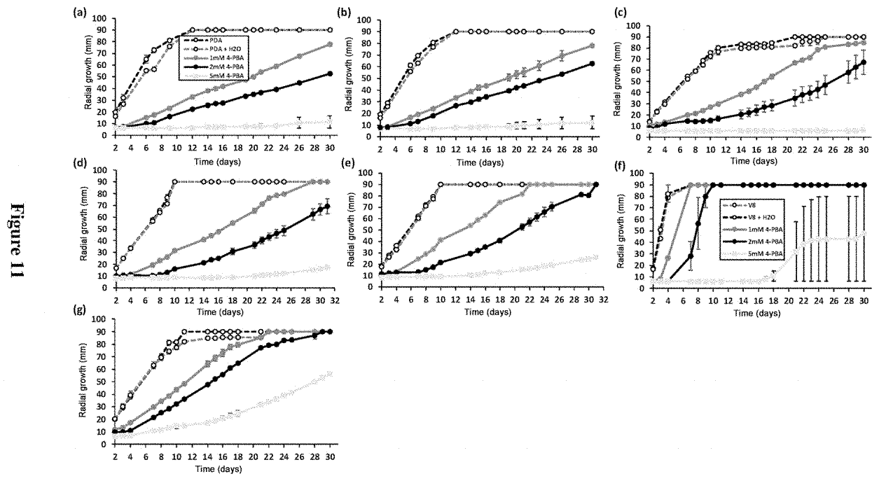

The experimental conditions and culture conditions are the same as those described in Example 3 (paragraph 1). The data presented in FIGS. 10 and 11 are from a single experiment comprising a biological duplicate (mean value±standard deviation). In FIG. 10, panel (a) shows the results obtained in radial growth for Fusarium graminearum, panel (b) for Fusarium verticilloides, panel (c) for Leptosphaeria maculans, panel (d) for Helminthosporium teres and panel (e) for Magnaporthe oryzae. In FIG. 11, panel a shows the results obtained for Fusarium oxysporum f. sp. melonis, panel b for Colletotrichum lindemuthianum, panel c for Alternaria solani, panels d and e for the respective strains 1 and 1509 of Alternaria brassicicola, panel (f) for Sclerotinia sclerotorum and panel (g) for Cercospora beticola. From these results, and where possible, the median inhibitory concentrations (designated EC₅₀) were calculated as in Example 3. The results obtained are presented in the Table 2 below. To allow for the different growth rates of the various fungal species, the EC₅₀ were all calculated for the day when the fungi cultured in control conditions (medium supplemented with water) had colonized the whole Petri dish.

TABLE 2

| | | Inhibition (%) | | | |
|---|---|---|---|---|---|
| | Time | 1 mM | 2 mM | 5 mM | |
| Fungi and oomycetes | (days) | 4-PBA | 4-PBA | 4-PBA | EC₅₀ |
| Fusarium graminearum | 6 | 48 | 97 | 99 | — |
| Fusarium verticilloides | 12 | 66 | 74 | 98 | 0.50 mM |
| Leptosphaeria maculans | 18 | 73 | 99 | 99 | — |
| Helmintosporium teres | 10 | 94 | 97 | 100 | 6.65 nM |
| Magnaporthe oryzae | 14 | 39 | 66 | 100 | 1.33 mM |
| Sclerotinia sclerotorum | 7 | 0 | 73 | 100 | 1.90 mM |
| Colletrotrichum lindemuthianum | 12 | 67 | 75 | 97 | 0.45 mM |
| Fusarium oxysporum f. sp melonis | 12 | 68 | 80 | 99 | 0.40 mM |
| Alternaria solani | 22 | 25 | 62 | 100 | 1.65 mM |
| Alternaria brassicicola (strain 1) | 10 | 70 | 88 | 97 | 0.26 mM |
| Alternaria brassicicola (strain 1509) | 10 | 58 | 81 | 96 | 0.64 mM |
| Cercospora beticola | 22 | 0 | 13 | 67 | 2.81 mM |
| Phytophthora parasitica | 10 | 95 | 99 | 100 | 0.24 nM |
| Phytophthora capsici | 9 | 90 | 100 | 100 | — |
| Phanerochaete chrysosporium | 4 | 99 | 100 | 100 | — |

Results. In order to determine the spectrum of potential action of 4-PBA, radial growth experiments were conducted on fungi attacking field crops (including colza, wheat, maize, barley and rice, see FIG. 10) and market gardening plants (including melon, bean, tomato, potato, cabbages and beet, see FIG. 11). It should be noted that all the fungi tested are sensitive to 4-PBA, suggesting that the molecule may be used for treating a wide range of cryptogamic diseases, in addition to gray rot. For the most recalcitrant fungi such as F. graminearum (FIG. 10a), the persistence of the molecule may be up to 10 days at the lowest concentration tested (i.e. 1 mM), and may be prolonged to 30 days for certain hypersensitive species such as Helminthosporium teres (FIG. 10d) and Colletotrichum lindemunthianum (FIG. 10b).

The median inhibitory concentrations, reported in Table 2, make it possible to compare the respective sensitivity of the different fungi and isolates to 4-PBA, independently of their growth rate. Thus, only the fungi S. sclerotorum and C. beticola have a sensitivity of an order of magnitude comparable to that of B. cinerea with an EC₅₀ between 2 and 3 mM (Table 2 and FIG. 6b). Overall, all the other fungi for which the data are reported in FIGS. 10 and 11 are 2 to 11 times more sensitive to 4-PBA than B. cinerea; apart from the fungus H. teres (responsible for helminthosporiosis of barley), which is the most sensitive of all with an EC₅₀ that is 450 000 times lower than that of B. cinerea.

All these results show that 4-PBA has broad spectrum fungistatic activity starting from a concentration of 1 mM. This activity is probably doubled for a fungicidal activity at higher concentrations (such as 2 and 5 mM), but the experiments carried out do not allow us to draw conclusions with certainty on this point.

### Example 7: Inhibition of the Radial Growth of Two Phytopathogenic Oomycetes by 4-PBA

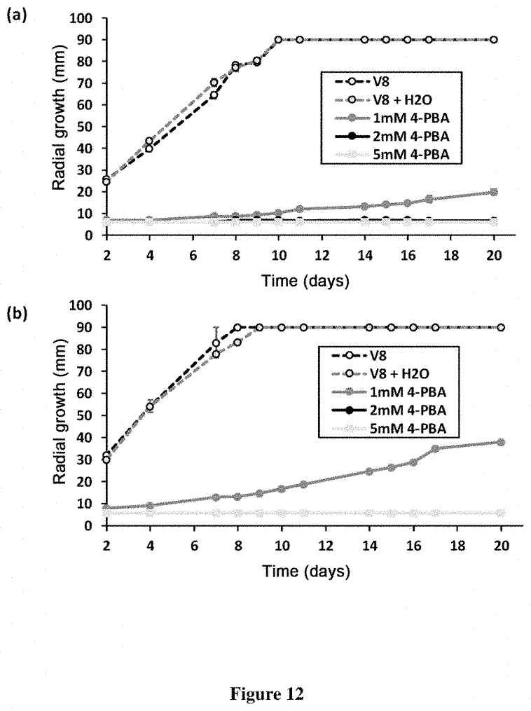

Material and Methods. The 2 oomycetes studied, as well as their respective growth temperature and culture medium, are described in Table 1 (above). The experimental conditions and culture conditions are the same as those described in Example 3 (paragraph 1). The data presented in FIG. 12 are from a single experiment comprising a biological duplicate (mean value±standard deviation). In this figure, panel (a) shows the results obtained in radial growth for Phytophthora parasitica and panel (b) for Phytophthora capsici. The EC₅₀ calculated for the first oomycete is reported in Table 2 (above).

Results. In the field or in the greenhouse, the oomycetes are responsible for cryptogamic diseases that are often difficult to eliminate other than by chemical treatment. Among these we may mention blight, which may develop on many vegetable species of agronomic interest (such as potato, tomato or grapevine).

Quite remarkably, the 2 oomycetes P. parasitica and P. capsici are by far the most sensitive microorganisms to 4-PBA among those we have tested (FIGS. 12a and b). In fact, the difference between EC₅₀ calculated for B. cinerea and for P. parasitica is 7 orders of magnitude (Table 2 and FIG. 6b). In other words, this oomycete is about 12 million times more sensitive to the molecule than the fungus.

These results demonstrate biostatic activity of 4-PBA with respect to the oomycetes studied starting from a final concentration of 1 mM, and suggest biocidal activity at higher concentrations, which may explain the complete absence of growth for 20 days of the 2 oomycetes at concentrations of 2 and 5 mM. They also allow extrapolation of the use of 4-PBA for treating cryptogamic diseases caused by oomycetes, in addition to that resulting from infection by fungi.

### Example 8: Inhibition of Radial Growth of the Mycelium of Phanerochaete chrysosporium by 4-PBA

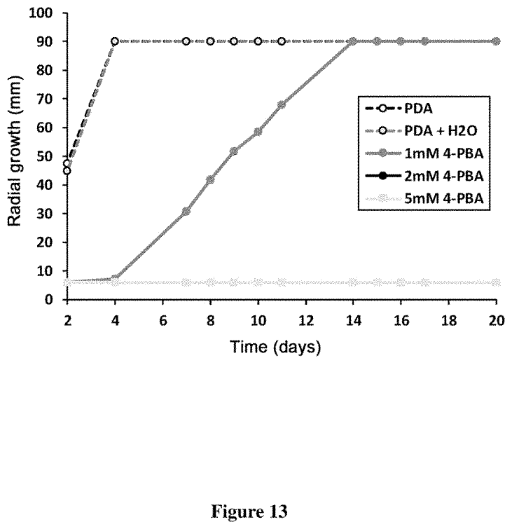

Material and Methods. The growth temperature and culture medium of the fungus Phanerochaete chrysosporium are described in Table 1 above. The experimental conditions and culture conditions are the same as those described in Example 3 (paragraph 1). The data presented in FIG. 13 are from a single experiment comprising a biological duplicate (mean value standard deviation).

Results. The fungus Phanerochaete chrysosporium is equipped with a set of enzymes allowing it to degrade lignin, a constituent of wood. This fungal species therefore does not attack live plants, but can cause degradation of construction lumber. It is responsible for white rot in dwellings.

In the experimental conditions used here, P. chrysosporium exhibits hypersensitivity to 4-PBA, since it is unable to develop at final concentrations of 2 and 5 mM (FIG. 13). Moreover, it takes 14 days for this fungus to overcome supplementation of the culture medium with 4-PBA at a level of 1 mM, or exactly twice as much time as is taken for B. cinerea to colonize the whole of the Petri dish in the same conditions (FIG. 6a).

These data demonstrate once again the antifungal activity of 4-PBA and make it possible to envisage a potential use of the molecule for treating construction lumber infected with fungi or preventing a possible infection.

### Example 9: Demonstration of the Antifungal Properties of 4-PBA on the Fungus Zymoseptoria tritici In Vitro

1. Inhibition of the Growth of the Primary Hypha of Z. tritici by 4-PBA

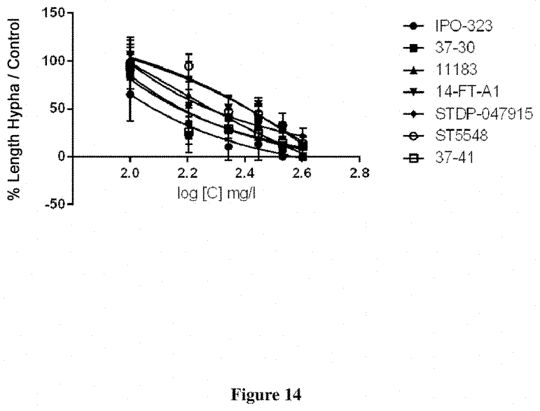

Material and Methods. The strain sIPO-323 was used for determining the sensitivity to 4-PBA of the fungus Zymoseptoria tritici (or Mycosphaerella graminicola, which is responsible for one of the main diseases of wheat: septoriosis). A suspension of spores of this isolate was prepared in sterile water treated by osmosis at a final concentration of 5·10⁶ spores/mL from cultures carried out for 4 days at 17° C. in the dark on solid medium at pH 5.9 (the composition of which was as follows: 20 g/L of malt extract, 5 g/L of yeast extract and 12.5 g/L of agar). The spore suspension thus obtained was then deposited at a rate of 300 μL per Petri dish containing a PG solid medium (10 g/L glucose, 2 g/L K₂IPO₄, 2 g/L KH₂PO₄, 12.5 g/l agar, pH 6.3). The medium was or was not supplemented with 4-PBA, at increasing concentrations, using a stock solution of the molecule prepared extemporaneously. A concentration range of 4-PBA from 100 mg/L (0.6 mM) to 400 mg/L (2.44 mM), and including six concentrations, was carried out (i.e. one experiment). After depositing the spore suspension, the solid media inoculated were incubated for 48 hours at 17° C. in the dark and the length of the primary hyphae was then measured under the microscope. The results presented in FIG. 14 are obtained from the mean value of the length of the primary hyphae per concentration. The length of the hyphae of each modality containing 4-PBA was normalized relative to the length of the hyphae of the modality without 4-PBA. These normalized data were used for calculating EC₅₀ (Table 3) by adjusting to a model with three parameters for sigmoid curves, as implemented in the GraphPad Prism software.

Results. The sensitivity to 4-PBA of the fungus Zymoseptoria tritici, responsible for septoriosis of wheat, was evaluated by measuring the inhibition of the growth of the primary hypha in vitro using the reference strain IPO-323. FIG. 14 in fact shows that two days after the start of the experiment, the decrease in average length of the primary hypha is greater as the concentration of 4-PBA increases.

Just as for examples 3, 6, 7 and 8, these data demonstrate the fungistatic activity of 4-PBA with respect to Z. tritici and thus extend its spectrum of action to an additional phytopathogenic fungus. It will be noted, moreover, that the efficacy of 4-PBA against this new fungus is comparable to that determined for the other fungi (Table 2 in Example 6), as witnessed by the calculated EC₅₀ of 0.657 mM (Table 3).

TABLE 3
Median inhibitory concentrations of 4-PBA determined experimentally
for seven isolates of the fungus Zymospetoria tritici.

| Isolates | IPO-323 | 37-30 | 11183 | 14-FT-A1 | STDP-047915 | ST5548 | 37-41 |
|---|---|---|---|---|---|---|---|
| EC₅₀ (mg/l) | 122.356 | 162.813 | 196.144 | 244.982 | 212.117 | 246.323 | 163.899 |
| EC₅₀ (mM) | 0.657 | 0.874 | 1.054 | 1.316 | 1.139 | 1.323 | 0.880 |

2. Inhibition, by 4-PBA, of the Growth of the Primary Hypha of Six Isolates of Z. tritici Resistant to Conventional Fungicides

Material and Methods. The sensitivity to 4-PBA of six isolates (pure strains) of the fungus Z. tritici, whose acquired resistance to conventional fungicides has been demonstrated genetically, was determined as described above (cf. section Material & Methods of point 1). A single experiment was carried out per isolate. This experiment included a concentration range per isolate and measurement of the length of 10 primary hyphae per concentration and per isolate. The corresponding data are presented in FIG. 14 and Table 3. The characteristics of the various isolates used are presented in Table 4.

Results. In a context where several strains of Z. tritici are selected for resistance to different classes of chemical fungicides commonly used (such as benzimidazoles, cytochrome b inhibitors, succinate dehydrogenase inhibitors or else inhibitors of demethylation of sterols), it was important to know whether 4-PBA could represent an alternative. For this, six isolates, whose acquired resistance had been characterized phenotypically and genotypically, were tested with respect to their sensitivity to 4-PBA. Just as for the reference strain IPO-323, FIG. 14 shows that the fungistatic activity of 4-PBA against these six pure strains is a function of the concentration used. Thus, 4-PBA is not only capable of limiting the growth of the primary hypha of an isolate having a single resistance to the benzimidazoles (isolate 37-30), but also of inhibiting that of isolates having multiple resistances, whether this phenotype is linked to a phenotype of enhanced efflux of the fungicide or not (isolates not “MultiDrug-Resistance” 14-FT-A1, STDP-047915 and ST-5548 and isolates “MultiDrug Resistance” 3741). However, EC₅₀ calculated for all of these isolates is of the same order of magnitude (about 1 mM), indicating once again that the efficacy of the molecule is comparable to that observed for other fungi (Examples 3, 6, 7 and 8).

TABLE 4
Characteristics of the seven isolates of the fungus Zymoseptoria tritici
tested with respect to their sensitivity to 4-PBA in vitro

| | Year and | | | | | |
|---|---|---|---|---|---|---|
| | Place of | Phenotype | | | | |
| Isolates | collection | Benzimidazoles | QoI | SDHI | DMI | MDR |
| IP0323 | Reference | Sensitive | Sensitive | Sensitive | Sensitive | no |
| 37-30 | 2017(FR) | Resistant | Sensitive | Sensitive | Sensitive | yes |
| | | (tub2 E198A) | | | | (type I) |
| 11183 | 2017(FR) | Sensitive | Sensitive | Sensitive | Sensitive | yes |
| | | | | | | (type I) |
| 14-FT-A1 | 2014 (UK) | Sensitive | Resistant | Sensitive | Resistant | no |
| | | | (cytb G143A) | | (cyp51 G28) | |
| STDP-047915 | 2015 (UK) | Resistant | Resistant | Resistant | Resistant | no |
| | | (tub2 E198A) | (cytb G143A) | (sdhC H152R) | (cyp51 G31) | |
| ST5548 | 2012(FR) | Resistant | Resistant | Resistant | Resistant | no |
| | | (tub2 E198A) | (cytb G143A) | (sdhC T79N) | (cyp51 G14) | |
| 37-41 | 2017(FR) | Resistant | Resistant | Resistant | Resistant | yes |
| | | (tub2 E198A) | (cytb G143A) | (sdhC H152R) | (cyp51 G35) | (type I) |

The phenotypes and genotypes of resistance to the fungicides, of the isolates described in this table may be found in detail in the work of Garnault et al. (Pest Manag. Sci., 2019, 75: 1794-1807). Abbreviations: DMI, sterol DeMethylation Inhibitor; MDR, Multi-Drug Resistance; QoI, Quinone outside inhibitor; SDHI, Succinate DeHydrogenase Inhibitor.

All these data inform indirectly on a potential mode of action of 4-PBA, probably showing that it is a new class of fungicides. Moreover, these results strongly suggest that 4-PBA could be used in certain circumstances for treating septoriosis of wheat, even when it is caused by strains of Z. tritici resistant to synthetic fungicides.

1-14. (canceled)

15. A method for preventing or treating a cryptogamic disease caused by a fungus or oomycete in a plant or a plant product, the method comprising a step of: applying an effective amount of 2-phenylbutyric acid (2-PBA), or 3-phenylbutyric acid (3-PBA), or 4-phenylbutyric acid (4-PBA), or a salt thereof, or a combination thereof, to the plant or to the soil surrounding the plant or to the plant product, wherein the effective amount is sufficient for destroying the fungus or oomycete or for inhibiting the germination or growth of the fungus or oomycete or for inhibiting the movement of the zoospores of oomycetes.

16. The method according to claim 15, wherein:
the fungus is selected from the phytopathogenic fungi belonging to the genera: Altemaria, Athelia, Armillaria, Aspergillus, Bipolaris, Blumeria, Botrytis (Cochliobolus), Carpenteles, Ceratocystis, Cercospora, Choanephora, Cladosporium, Claviceps, Colletotrichum, Cryphonectria, Diaporthe (Phomopsis), Erysiphe, Eurotium, Fusarium, Ganoderma, Gibberella, Glomerella, Magnaporthe, Macalpinomyces, Melampsora, Monilia, Moniliophthora, Microcyclus, Mycena, Mycosphaerella, Nectria, Neonectria, Olpidium, Penicillium, Pestalotia, Phakopsora, Phanerochaete, Phellinus, Physoderma, Pleospora, Podosphaera, Puccinia, Rhizoctonia, Rhizopus, Sclerotinia, Seiridium, Stemphylium, Septoria, Sphaerotheca, Sporisorium, Synchytrium, Taphrina, Tilletia, Thanatephorus, Trichoderma, Typhula, Ulocladium, Ustilago, Urocystis, Uromyces, Verticillium, and Zymoseptoria; and
the oomycete is selected from the phytopathogenic oomycetes belonging to the genera: Albugo, Aphanomyces, Bremia, Peronospora, Peronosclerospora, Phytophthora, Plasmodiophora, Plasmopara, Polymyxa, Pseudoplasmopara, Pythium, Sclerophthora, and Sclerospoara.

17. The method according to claim 15, wherein the plant is a field crop, a vegetable, an ornamental plant, a tree or a shrub.

18. The method according to claim 15, wherein the plant belongs to the family Malvaceae, Solanaceae, Cucurbitaceae, Cruciferae or Brassicaceae, Compositae or Asteraceae, Umbelliferae or Apiaceae, Liliaceae or Asparagaceae, Rosaceae, Polygonaceae, Lamiaceae, Vitaceae, Fabaceae, Poaceae, Liliaceae, Rubiaceae, Musaceae, Orchidaceae, Lauraceae, Alliaceae, Chenopodiaceae, Valerianaceae, Caprifoliaceae, Verbenaceae, Plantaginaceae, Scrofulariaceae, Ericaceae, Primulaceae, Oleaceae, Apocynaceae, Asclepiadaceae, Gentianaceae, Boraginaceae, Araliaceae, Grossulariaceae, Myrtaceae, Eleagnaceae, Lythraceae, Onagraceae, Thymeleaceae, Passifloraceae, Tiliaceae, Bombacaceae, Linaceae, Geraniaceae, Rutaceae, Violaceae, Cistaceae, Hypericaceae, Theaceae, Myristicaceae, Papaveraceae, Fumariaceae, Anonaceae, Renonculaceae, Caryophyllaceae, Fagaceae, Juglandaceae, Urticaceae, Moraceae, Santalaceae, Cannabinaceae, Piperaceae, Salicaceae, Betulaceae, Arecaceae, Zingiberaceae, Bromeliaceae, Pinaceae, Cupressaceae, Ginkgoaceae, Cycadaceae, Equisetaceae, Lycopodiaceae or Selaginellaceae.

19. The method according to claim 15, wherein the plant product is selected from seeds, tubers, fruits after harvesting, vegetables after harvesting, post-harvest grains, pre-prepared food products, and post-cut wood.

20. The method according to claim 15, wherein the cryptogamic disease is selected from the group consisting of gray rot or botrytis, mildew or blight, Fusarium disease, cercosporiosis, oidium, alternariosis, anthracnosis, smuts, stinking smuts, septorioses, moniliosis or monilia, rusts, helminthosporiosis, sclerotiniosis, scab, verticilliosis, cladosporiosis, blister, coryneum or shot-hole disease, entomosporiosis, damping-off, esca, eutypiosis, gummosis, stony pit virus, mal secco, black leg, rice blast disease, and Dutch elm disease.

21. The method according to claim 15, wherein the cryptogamic disease is caused by a fungus or a oomycete resistant to at least one conventional fungicide.

22. The method according to claim 15, wherein the cryptogamic disease is septoriosis of wheat caused by the fungus Zymoseptoria tritici.

23. A method for improving the storage of a plant product that is susceptible to being affected by a phytopathogenic fungus or oomycete, the method comprising a step of applying an effective amount of 2-PBA, or 3-PBA, or 4-PBA, or a salt thereof, or a combination thereof, to the plant product, wherein the effective amount is sufficient for destroying the fungus or oomycete or for inhibiting the germination or growth of the fungus or oomycete or for inhibiting the movement of the zoospores.

24. The method according to claim 23, wherein:
the fungus is selected from the phytopathogenic fungi belonging to the genera: Altemaria, Athelia, Armillaria, Aspergillus, Bipolaris, Blumeria, Botrytis (Cochliobolus), Carpenteles, Ceratocystis, Cercospora, Choanephora, Cladosporium, Claviceps, Colletotrichum, Cryphonectria, Diaporthe (Phomopsis), Erysiphe, Eurotium, Fusarium, Ganoderma, Gibberella, Glomerella, Magnaporthe, Macalpinomyces, Melampsora, Monilia, Moniliophthora, Microcyclus, Mycena, Mycosphaerella, Nectria, Neonectria, Olpidium, Penicillium, Pestalotia, Phakopsora, Phanerochaete, Phellinus, Physoderma, Pleospora, Podosphaera, Puccinia, Rhizoctonia, Rhizopus, Sclerotinia, Seiridium, Stemphylium, Septoria, Sphaerotheca, Sporisorium, Synchytrium, Taphrina, Tilletia, Thanatephorus, Trichoderma, Typhula, Ulocladium, Ustilago, Urocystis, Uromyces, Verticillium, and Zymoseptoria; and
the oomycete is selected from the phytopathogenic oomycetes belonging to the genera: Albugo, Aphanomyces, Bremia, Peronospora, Peronosclerospora, Phytophthora, Plasmodiophora, Plasmopara, Polymyxa, Pseudoplasmopara, Pythium, Sclerophthora, and Sclerospoara.

25. The method according to claim 23, wherein the plant product is selected from seeds, tubers, fruits after harvesting, vegetables after harvesting, post-harvest grains, pre-prepared food products, and post-cut wood.

26. The method according to claim 23, wherein the cryptogamic disease is caused by a fungus or a oomycete resistant to at least one conventional fungicide.

27. A method for protecting seeds and/or for improving the emergence of seedlings, the method comprising a step of applying a sufficient amount of 2-PBA, or 3-PBA, or 4-PBA, or a salt thereof, or a combination thereof, to seeds intended for sowing, wherein the seeds are susceptible to being affected by a phytopathogenic fungus or oomycete and wherein the effective amount is sufficient for destroying the fungus or oomycete or for inhibiting the germination or growth of the fungus or oomycete or for inhibiting the movement of the zoospores of oomycetes.

28. The method according to claim 27, wherein the cryptogamic disease is caused by a fungus or a oomycete resistant to at least one conventional fungicide.

29. The method according to claim 27, wherein the phytopathogenic fungus or oomycete is responsible for damping-off.

30. A phytosanitary composition comprising, as a fungicide or fungistatic agent, 2-PBA, or 3-PBA, or 4-PBA, or a salt thereof, or a combination thereof.

31. A solution for coating or forming a film on seeds, comprising, as fungicide or fungistatic agent, 2-PBA, or 3-PBA, or 4-PBA, or a salt thereof, or a combination thereof.
